(19) United States
(12) Patent Application Publication
(10) Pub. No.: US 2014/0133177 A1
(43) Pub. Date: May 15, 2014

(54) LCD BACKLIGHT COMPONENT COATINGS FOR REDUCING LIGHT LOSSES AND IMPROVING IN-STACK LIGHT COLLIMATION

(71) Applicant: LIGHT POLYMERS HOLDING, George Town (KY)

(72) Inventors: Samuel Miller, Chino Hills, CA (US); Marc McConnaughey, Chino, CA (US); Evgeny Morozov, Burlingame, CA (US); Evgeni Poliakov, San Mateo, CA (US)

(73) Assignee: LIGHT POLYMERS HOLDING, George Town (KY)

(21) Appl. No.: 14/159,704

(22) Filed: Jan. 21, 2014

Related U.S. Application Data
(63) Continuation-in-part of application No. 13/869,041, filed on Apr. 24, 2013.

(51) Int. Cl. F21V 8/00

(52) U.S. Cl. CPC G02B 6/005; G02B 6/0065
USPC 362/607; 29/458

(57) ABSTRACT

Provided are multilayer stacks for backlight units in LCD panels and methods for forming thereof. The stacks include refractive index matching layers and pressure sensitive adhesives to minimize light losses. More particularly, the stacks comprise a reflector, a light guide, a course diffuser, one or more brightness enhancing films, and a fine diffuser. A refractive index matching layer is deposited onto at least one surface of the backlight components. A pressure sensitive adhesive is deposited onto the refractive index matching layers. Alternatively, the stacks comprise two or more refractive index matching layers on each surface of the backlight components and retain an air gap between the backlight components. The refractive index matching interlayers are based on a polymer solution having about 0.1%-30% by weight of specific rigid rod-like polymer molecules. The molecules may include various cores, spacers, and sides groups to ensure their solubility, viscosity, and cross-linking ability.

### CROSS-REFERENCE TO RELATED APPLICATIONS

This application is a continuation-in-part of U.S. patent application Ser. No. 13/869,041, entitled “DEPOSITING POLYMER SOLUTIONS TO FORM OPTICAL ELEMENTS,” filed on Apr. 24, 2013, which is incorporated herein by reference in its entirety.

### TECHNICAL FIELD

This disclosure relates generally to liquid crystal display (LCD) backlights and, more particularly, to reducing light losses due to reflections at the surfaces of optical elements, to reducing light scattering at the surfaces of optical elements, and to improving light collimation at the surfaces of optical elements in LCD backlights.

### DESCRIPTION OF RELATED ART

The approaches described in this section could be pursued, but are not necessarily approaches that have previously been conceived or pursued. Therefore, unless otherwise indicated, it should not be assumed that any of the approaches described in this section qualify as prior art merely by virtue of their inclusion in this section.

Optical polymers have specific characteristics, such as relatively high and/or anisotropic refractive index, that make these polymers suitable for various optical applications. For example, optical grade poly-methyl methacrylate (PMMA), and polycarbonate have been used as fiber optic core materials, as optical elements in LCD backlights, and plastic lenses and films, while silicon resins and silica have been used as fiber claddings. However, the refractive index of PMMA is about 1.49, and the refractive index of polycarbonate is about 1.59. These values may not be sufficient to optimally capture the light in an LCD backlight and direct it toward the LCD panel with optimized collimation of light when air gaps separate the elements in the backlight. Many researchers strive to develop polymers with unique refractive index values permitting innovation of new approaches to reduce reflection losses and improve collimation of light transmitted from the backlight to the LCD panel.

Optical polymers can be used in backlight units of an LCD panel. A typical edge lighted backlight unit can include two diffusers, for example, a coarse diffuser and a fine diffuser, one or two brightness enhancing films (BEFs), a light guide, and a reflector. The coarse diffuser can be located close to the light guide, one or two BEF that direct the light exiting from the coarse diffuser along a path substantially perpendicular to the plane associated with the BEFs, and the fine diffuser can be located near a rear polarizer stack adjacent to the LCD. The reflector can be located on a side of the light guide opposite the diffusers and BEFs. The light exiting the light guide can fall on the rear surface of the coarse diffuser at a low angle relative to the plane of the coarse diffuser. The coarse diffuser can homogenize the light falling on its rear surface, smoothing out hot spots and dark areas, and creating a more uniform light distribution across the surface of the diffuser. The coarse diffuser can redirect the light that exits any point on the diffuser to fall within a specified solid angle with additional skew rays that lie outside this solid angle. Some of the light in this solid angle and the skew rays may lie outside the solid angle of efficient capture of the subsequent BEF in the backlight unit and as a result does not contribute to the light usable by the LCD panel. Similarly, a BEF can redirect light that exits at any point on the BEF to fall within a specified solid angle with additional skew rays that lie outside this solid angle. Some of the light in this solid angle and the skew rays may lie outside the solid angle of efficient capture of the subsequent BEF or fine diffuser and as a result does not contribute to the light usable by the LCD panel. This may reduce the efficiency of the backlight. Some of the light rays that exit the fine diffuser lie within the specified solid angle of the fine diffuser with additional skew rays that lie outside the solid angle. Some of this light in this solid angle and the skew rays cannot be efficiently processed by the front and rear polarizer stacks or the LCD panel and as a result does not contribute to the light usable by the LCD panel. The cumulative impact of the light that cannot be efficiently processed by the LCD panel is to effectively reduce the contrast ratio of the display and diminish image quality of the display. The LCD panels and the front and rear polarizer stacks can create the best quality images when all light enters perpendicularly with respect to the plane of the LCD panel. Current technology reflectors, light guides, diffusers and BEFs do not meet this criterion since these components redirect light to lie within a specified solid angle with respect to the normal to the backlight assembly and all scatter light producing skew rays that fall outside the specified solid angle of these components. Additionally, there are air gaps between the reflector and the rear surface of the light guide, the light guide and the rear surface of the coarse diffuser, the front surface of the coarse diffuser and the rear surface of the BEF, between the front surface of the BEF and the rear surface of a second BEF (if present), between the front surface of a final BEF and the rear surface of the fine diffuser, and between the front surface of the fine diffuser and the first film of the rear polarizer stack. At each air gap, additional light can be lost due to reflections with scattering caused by index of refraction mismatches between the optical components and the air gaps, further reducing the light processing efficiency of the overall backlight unit. These air gaps, using present technology, must be present for the diffusers and BEFs to function. A pressure sensitive adhesive (PSA) with a refractive index that matches the indexes of the diffusers or BEFs can negate the functionality of these components. Additionally, a PSA with a refractive index that matches the indexes of the reflector and light guide can negate the functionality of these components. There are low index of refraction coatings that can reduce reflections at the reflector, light guide, diffusers and BEFs air gap boundaries These coatings are however complex and prohibitively expensive for use in a consumer LCD backlight. A directly lighted backlight unit can use similar coarse diffusers, BEFs, and fine diffusers. These components may have problems similar to those described with reference to the edge lighted backlight unit.

FIG. 1 shows a high level diagram of an example of an LCD backlight 100, which consists of multiple layers including a reflector 105, a light guide 115, an air gap 110 between the reflector 105 and light guide 115, a coarse diffuser 125, an air gap 120 between the light guide 115 and coarse diffuser 125, a BEF #1 135, an air gap 130 between the coarse diffuser 125 and the BEF #1 135, a BEF#2 145 (if present), an air gap 140 between the BEF #1 135 and the BEF #2 145, a fine diffuser 155, an air gap 150 between the BEF#2 145 and the fine diffuser 155, the rear polarizer stack 170, and air gap 160 between the fine diffuser 155 and the rear polarizer stack 170, an LCD cell 180, and a front polarizer stack 190.

As will be appreciated by those skilled in the art, as a light beam goes through the multilayer stack, e.g., stack 100, it is subject to multiple reflections, scattering, refractions, and losses at every boundary between a component and an air gap. The light losses may be as large as about 4% at a typical plastic-air boundary, for example at the boundary of the light guide 115 and air gap 120, or even larger between the air gap 140 and the BEF #1 135 as they depend on the refractive index mismatch between the layers and angle of light incidence. The reflections, scattering, and refractions of light of various kinds or nature may generate problems such as unwanted changes in color, brightness, and contrast in addition to said light losses.

FIG. 2 shows a high level diagram of another multilayer LCD stack 200 involving the use of a low index of refraction PSA in place of each air gap. The stack 200 consists of multiple layers including a reflector 205, a light guide 215, a PSA 210 between the reflector 205 and light guide 215, a coarse diffuser 225, a PSA 220 between the light guide 215 and coarse diffuser 225, a BEF #1 235, a PSA 230 between the coarse diffuser 225 and the BEF #1 235, a BEF#2 245 (if present), a PSA 240 between the BEF #1 235 and the BEF #2 245, a fine diffuser 255, a PSA 250 between the BEF#2 245 and the fine diffuser 255, the rear polarizer stack 270, and a PSA 260 between the fine diffuser 255 and the rear polarizer stack 270, an LCD cell 280, and a front polarizer stack 290. The index of refraction for each PSA can be chosen as the average of the indexes of refraction of two adjacent components. By way of example, for light guide 215 and coarse diffuser 225, the index of refraction of the PSA 220 can be chosen to be the simple average of the index of refraction of the light guide 215 and the index of refraction of the coarse diffuser 225. Given that both the light guide 215 and coarse diffuser 225 have near identical indices of refraction, the selected index of refraction of the PSA would be almost identical to that of both light guide 215 and coarse diffuser 225. The result would be, as can be appreciated by those skilled in the art, that light would travel in a straight line between the two components, negating the function of both. Similarly, the index of refraction of PSAs 210, 230, 240, and 250 chosen as an average of the indexes of refraction of their adjacent components would negate the function of these components. The PSA 260 would negate the function of the fine diffuser 255.

One of the major reasons behind the problems of light losses and unwanted scattering, reflection, and refraction of light within the stacks 100 is the variation and mismatch of refractive indexes (n) among adjacent layers. For example, a typical refractive index for the light guide 115 is n˜1.5-1.58, refractive index for the air gap 110 is n˜1.0. It is desirable to reduce the above described negative effects of index mismatch without damaging the optical properties of each LCD backlight component.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

According to aspects of the present disclosure, provided are single layer or multilayered coatings for the reflector, light guide, diffusers, and BEFs in an LCD backlight that permit the use of low cost index matching PSAs or air gaps between the reflector, light guide, diffusers, BEFs, and before the rear polarizer stack that will result in a more efficient backlight, reducing light losses in the backlight, and improving light collimation with reduced scattering, resulting in more usable light at the rear polarizer stack, the LCD panel, and the front polarizer stack. More particularly, the backlight units comprise at least a reflector, a light guide, a course diffuser and a fine diffuser, and one or more brightness enhancing films. One or more high index of refraction coatings are deposited on the one and only one side of the elements of the backlight units with the possible exception of the light guide. In some instances it may be desirable to coat both surfaces of the light guide with a high index of refraction coating. One or more pressure sensitive adhesives can be deposited onto one or more high index of refraction coatings. In various embodiments, high index of refraction coatings and the pressure sensitive adhesive are intelligently selected so as to collimate light propagating through the backlight, reduce light scattering, and reduce light losses.

Alternatives or additional embodiments may comprise two or more high index of refraction coatings forming a complex multilayer coating on each surface of the backlight components, but retain the air gap between each of these backlight components while reducing light losses due to reflections, light scattering and improving light collimation of the backlight assembly.

According to another aspect of the present disclosure, a method for forming a multilayer stack for reducing light losses in an LCD backlight is provided. The method comprises providing a reflector, a light guide, a course diffuser, a brightness enhancing film, and a fine diffuser. After providing the elements of the multilayer stack, a high index of refraction coating is deposited onto at least one surface of the reflector, the light guide, the course diffuser, the brightness enhancing film, and the fine diffuser. Typically this high index of refraction coating would be applied to the front surface of the component, the surface nearest the LCD. The rear surface would remain uncoated with the possible exception of the light guide. After depositing the high index of refraction coating, a pressure sensitive adhesive with a selected index of refraction is deposited onto the high index of refraction coating. After depositing the pressure sensitive adhesives, the light guide is placed on the reflector, the course diffuser is placed on the light guide, the brightness enhancing film is placed on the course diffuser, and the fine diffuser is placed on the brightness enhancing film. A PSA with an index of refraction in the range of 1.47 to 1.51 is suitable for this application.

### BRIEF DESCRIPTION OF THE DRAWINGS

Embodiments are illustrated by way of example, and not by limitation in the figures of the accompanying drawings, in which like references indicate similar elements and in which:

FIG. 1 shows an example of a traditional multicomponent backlight unit with air gaps separating the components.

FIG. 2 shows an example of a traditional multicomponent backlight unit with PSAs separating the components.

FIG. 3 is a high level illustration of a coordinate system associated with an optical element.

FIG. 4 is an expanded view of a backlight unit, in accordance with some embodiments.

FIG. 5 is a high level drawing of two adjacent components in a backlight unit where the front surface of one component receives a high index of refraction coating and the two components are joined with an index matching PSA.

FIG. 6 is a detailed drawing of a backlight unit where the front surface of each component receives a high index of refraction coating and adjacent components are joined with an index matching PSA.

FIG. 7 is a high level drawing of two adjacent components in a backlight unit where the front and rear surfaces of each component receive a complex multilayer coating of at least two layers and adjacent components are joined with an air gap.

FIG. 8 is a detailed drawing of a backlight unit where the front and rear surfaces of each component receive a complex multilayer coating of at least two layers and adjacent components are joined with an air gap.

FIGS. 9A-9B show a high level block diagram of yet another example of a multilayer stack that employs a refractive index matching interlayer.

FIG. 10 shows a high level block diagram of a method for using high index of refraction coatings on a surface of backlight components and index matching PSAs to reduce light losses in an LCD backlight, in accordance with various embodiments.

FIG. 11 shows a high level block diagram of a method for using complex multilayer coatings, with at least two layers, on both surfaces of backlight components and air gaps between components to reduce light losses in an LCD backlight, in accordance with various embodiments.

FIG. 12 is a high level illustration of an example substrate having one surface coated with a polymer material.

FIG. 13A shows an example dry thickness dependency against wet thickness for a polymer solution deposited onto a substrate.

FIG. 13B shows an example thickness retardation dependency against dry thickness for a polymer solution deposited onto a substrate.

FIG. 14 shows measured dependencies of viscosity as a function of shear rate for different polymer concentrations.

FIGS. 15A-15B show an example grooving process of a polymer solution layer deposited onto a substrate.

FIG. 16 shows a dependency of refractive indexes of certain layers of optical elements against a wavelength.

FIG. 17 shows an in-plane dependency of a refractive index against a wavelength.

### DETAILED DESCRIPTION OF EXAMPLE EMBODIMENTS

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

### Introduction

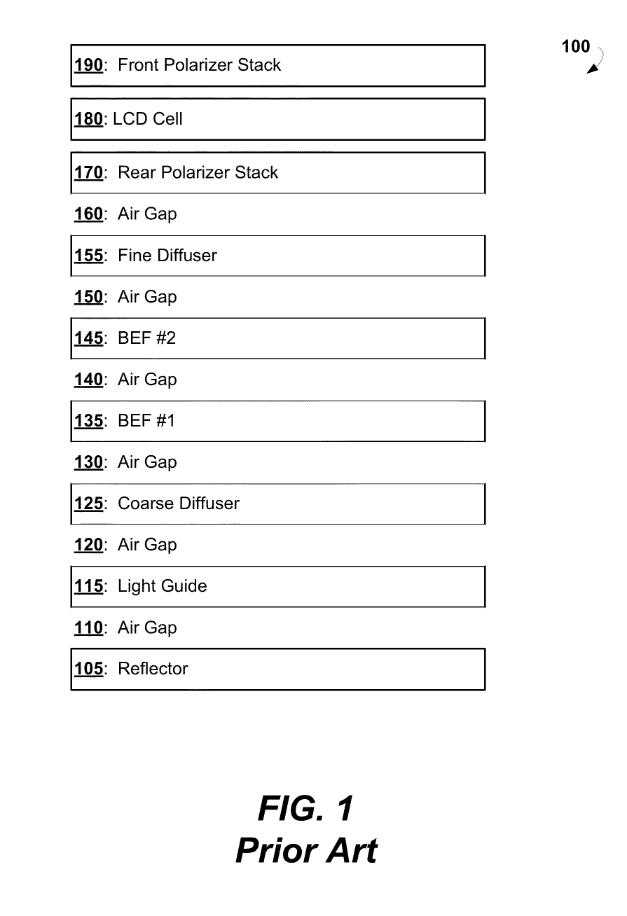

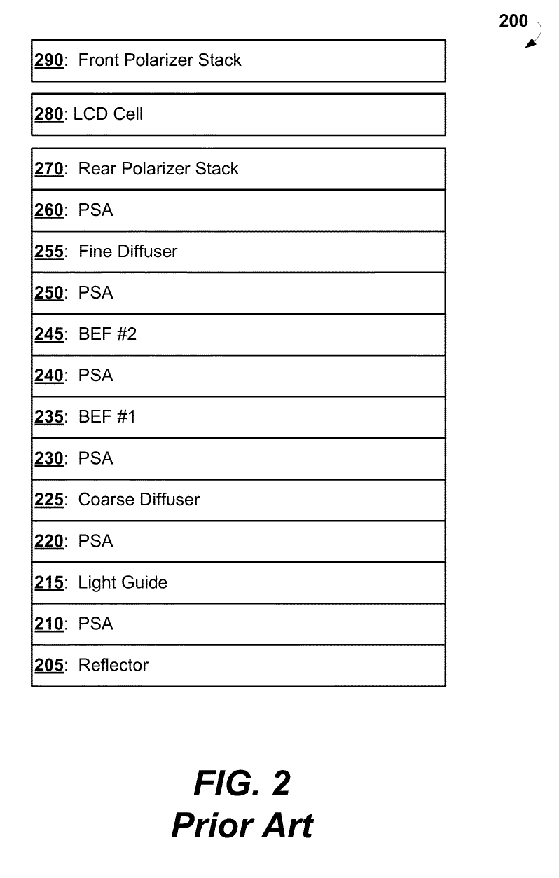

Within the solution to the problems of light losses and unwanted scattering, reflection, and refraction of light discussed above with reference to FIGS. 1 and 2, two distinct areas of improvement may be distinguished.

The first improvement may consist of coating the light guide, the reflector, the diffuser structures on the diffuser substrate, and the BEF structures on the BEF substrate with a high index of refraction material. The term “high index of refraction material” may be taken to mean a coating with an average index of refraction n_{c} that is higher than the average index of refraction nₘ of the reflector material, light guide material, diffuser material, or BEF material. The difference between n_{c} and nₘ should be as high as possible. Reflectors, currently, can be implemented with aluminized substrates or Titanium Dioxide coated substrates. In some cases, simple white plastic may be used. These materials have their own indexes of refraction. Light guide structures, diffuser structures, and BEF structures can be implemented on materials such as PMMA, Poly Carbonate (PC), Polyethylene Terephthalate (PET), Poly Butylenes Terephtalate (PBT), Poly Ethylene (PE), and other materials or combinations of materials. These materials typically have an index of refraction in the range of 1.47 to 1.58. Coatings with an index of refraction that is larger than the index of refraction of the diffuser or BEF material may collimate the light exiting from the diffusers and BEFs and entering the coating layer. Depending on the coating thickness and characteristic size of the surface features of the diffuser or BEF, the solid angle of the light exiting from any point on the surface may be reduced. At the same time, the original function of the diffuser, to homogenize the light passing through the diffuser thereby removing bright areas, darker areas, and structural images such as the BEF prisms from the light entering the LCD rear polarizer stack, will not be impaired. Because the light entering the rear polarizer stack may be more highly collimated and contain fewer skew rays, the extinction ratio of the light exiting the crossed polarizers and dark LCD panel may be greater, thereby increasing the contrast ratio of the display, and light may be more efficiently used in the LCD panel resulting in a brighter display for the same light energy input into the rear polarizer stack.

The second component of the solution is to join adjacent coated components, the reflector, the light guide, the coarse diffuser, the first and second BEFs, the fine diffuser, and the rear polarizer stack with an index matching gel or PSA to reduce reflection losses at the surfaces of these components. By way of example, if the first BEF has an index of refraction of 1.51 and the coating on the coarse diffuser has an index of 1.70, a PSA with an index of 1.51 may be used. Using the traditional air gap between the output of the coarse diffuser and the rear of the first BEF, light losses at the BEF surface to reflections is 4% per single substrate/air interface at normal incidence. Light losses at the surface of the coarse diffuser are 6.7%. Some but not all of this light will be recovered by reflection recapture. Light that may be recaptured may not necessarily be in a path that will lead to efficient use by a subsequent component. If a PSA with an index of refraction of 1.51 is used to attach the coated coarse diffuser to the BEF, losses at the diffuser-PSA interface may reduce to approximately 0.35%, before reflection recapture. If the BEF material has an index of 1.51, light loss at the PSA-BEF interface may be zero. Similar arguments can be made for attaching the reflector to the light guide, to the coarse diffuser, to the first BEF, to the second BEF, the BEF to the fine diffuser, and the fine diffuser to the first film in the rear polarizer stack. It is recognized that light losses may be further reduced and collimation improved by utilizing a PSA that is better refractive index matched to the index of refraction of the coating on one component and the index of refraction of the adjacent component. Such a PSA may not however be commonly available or may be too expensive to justify its use. In any event, use of a PSA with an index of refraction of 1.51, as in the example, matching the index of refraction of the BEF is sufficient to demonstrate significant reduction in reflection losses and attendant skew rays.

As an alternative to using a pressure sensitive adhesive to reduce light losses between the reflector and light guide, light guide and coarse diffuser, coarse diffuser and first BEF, first BEF and second BEF, second BEF to fine diffuser, and fine diffuser to rear stack, it is possible to retain the air gap between these components and still reduce light losses due to reflections by applying a complex multilayer coating with at least two coatings of special index of refraction material on both surfaces of each component in the backlight. This combination of the first and second complex coatings on each surface may have the effect of reducing the reflection losses at the air gap.

In example embodiments, it is possible to consider a mix of approaches within a single backlight unit. In some instances, components may be coated with a high index of refraction material and adjacent components may be joined using a PSA. Other components in the stack may simply have their reflection losses reduced by using a dual coating with the complex index of refraction material on surfaces of each of two adjacent components.

According to embodiments of the present disclosure, a refractive index (RI) matching layer may be a polymer based material or liquid-soluble material. In an example, applicable polymer materials may include between about 0.1% and 30% or even between 1% and 10% by weight of a specific rigid rod-like polymer molecules. Solvents used in the polymer solutions may include a wide range of substances such as polar protic solvents, polar aprotic solvents, and non-polar solvents. The polymer molecules may have a chain length of between about 5,000 and 100,000 unified atomic mass units; however, it should be noted that optimal chain lengths and molecular weight in general may depend on the polymer concentration in the polymer solution, viscosity, temperature, and many other chemical and physical parameters of deposition and post-deposition processes. The size of polymer chains allows aligning the polymer molecules at least in the coating direction so as to achieve desired refractive indices for the optical element.

The polymer solutions may be deposited onto a substrate using the following techniques: slot die, spraying, molding, roll-to-roll coating, Mayer rod coating, roll coating, gravure coating, micro-gravure coating, comma coating, knife coating, extrusion, printing, dip coating, and so forth. For example, a slot die technique may involve forcing under pressure a polymer solution from a reservoir through a slot onto a moving substrate. The slot may have a much smaller cross-section than the reservoir and may be oriented perpendicularly to the direction of the substrate movement. A combination of the pressure, size of the slot width, gap between the slot and the substrate, and substrate moving speed as well as various polymer solution characteristics described above provide for specific orientation of the molecules.

The substrates used for polymer solution deposition may include a polymer substrate, glass substrate, TAC (triace tyl cellulose) substrate, polypropylene substrate, polycarbonate substrate, PET, polyacrylic substrate, PMMA substrate, and so forth. The substrates may be treated using one or more techniques prior to deposition of the polymer solution so as to improve wettability and/or adhesion of the polymer solution deposited onto the substrate. In particular, the treating techniques may include one or more of the following: cleaning (e.g., ultrasound cleaning), leaching and/or oxidizing using mildly alkaline water solution, saponification, depositing a primer layer (e.g., silane or polyethyleneimine), and modifying surface relief of the substrate by subjecting it to corona discharge or plasma discharge utilizing various gases and vapors, and an electron or ion beam. The pre-deposition techniques may also include an addition of additives to the polymer solutions. The additives may include plasticizing agents, antioxidants, surfactants, formability agents, stabilizers, nonylphenoxypoly glycidol, alcohols, acids, and hindered phenol or other low molecular weight materials and polymers.

In general, the polymer solutions may be isotropic prior to deposition and have no preferred direction for molecule orientation. However, various post-deposition techniques may be employed to achieve a desired orientation of the molecules or specific optical properties. Post-deposition techniques may include, for example, cross-linking, specific drying techniques, techniques to evaporate solvents from polymer solutions, IR light radiation, heating, subjecting to a drying gas flow, shaping, and so forth.

The specifically designed polymers and deposition processes may have high refractive index values, for example, in between about 1.5 and 1.8 within a portion of the visible range, and more specifically between 1.6 and 1.7.

### DEFINITIONS

The term a “visible spectral range” refers to a spectral range having the lower boundary of approximately 400 nm and the upper boundary of approximately 700 nm.

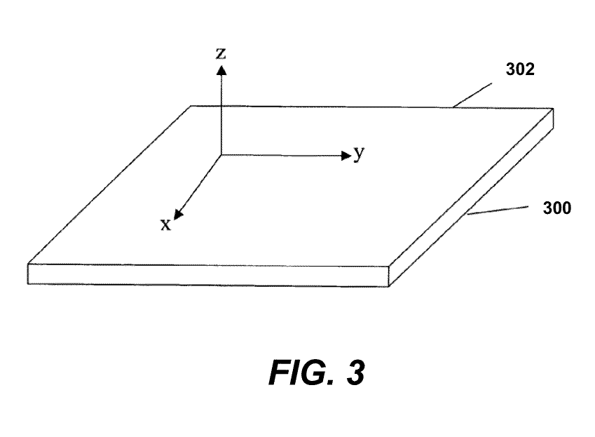

The term “retardation layer” refers to an optically anisotropic layer, which can alter the polarization state of a light wave traveling through the anisotropic layer and which is characterized by three principal refractive indices (nₓ, n_{y} and n_{z}) associated with Cartesian coordinate system related to the deposited polymer solution layer or the corresponding optical element based thereupon. Two principal directions for refractive indices nₓ and n_{y} may belong to the xy-plane coinciding with a plane of the retardation layer, while one principal direction for refractive index (n_{z}) coincides with a normal line to the retardation layer. This is further illustrated in FIG. 3, which shows an optical element including a substrate 300 with the deposited polymer solution 302 and an axis system (e.g., Cartesian coordinate system) having orthogonal axes x, y, and z. In various embodiments, at least two refractive indices among nₓ, n_{y}, and n_{z} have different values. The term “retardation layer” may also refer to an optical element that divides an incident monochromatic polarized light into components and introduces a relative retardance or phase shift between them.

The term “optically anisotropic retardation layer of negative C-plate type” refers to an optical layer with refractive indices nₓ, n_{y}, and n_{z} satisfying the following condition in the visible spectral range: n_{z}<nₓ=n_{y}.

The above definitions are invariant to rotation of system of coordinates (of the laboratory frame) about the vertical z-axis for all types of anisotropic layers.

The term “C-plate” may refer to a birefringent optical element, such as, for example, a plate or film, with a principal optical axis (often referred to as the “extraordinary axis”) substantially perpendicular to the selected surface of the optical element. The principle optical axis corresponds to the axis along which the birefringent optical element has an index of refraction different from the substantially uniform index of refraction along directions normal to the principle optical axis. For example, a C-plate using the axis system illustrated in FIG. 3 with nₓ=n_{y}≠n_{z}, where nₓ, n_{y}, and n_{z} are the indices of refraction along the x, y, and z axes, respectively. The optical anisotropy is defined as Δn_{zx}=n_{z}−nₓ. For purposes of simplicity, Δn_{zx} will be reported as its absolute value.

The term “biaxial retarder” may refer to a birefringent optical element, such as, for example, a plate or film, having different indices of refraction along all three axes (i.e., nₓ≠n_{y}≠n_{z}). Biaxial retarders can be fabricated, for example, by biaxially orienting plastic films. In-plane retardation and out of plane retardation are parameters used to describe a biaxial retarder. As the in-plane retardation approaches zero, the biaxial retarder element behaves more like a C-plate. Generally, a biaxial retarder, as defined herein, has an in-plane retardation of at least 3 nm for 550 nm emitting light wavelength. Retarders with lower in-plane retardation are considered C-plates.

The term “polymer” should be understood to include polymers, copolymers (e.g., polymers formed using two or more different monomers), oligomers and combinations thereof, as well as polymers, oligomers, or copolymers that can be formed in a miscible blend by, for example, coextrusion or reaction, including transesterification. Both block and random copolymers are included, unless indicated otherwise.

The term “polarization” refers to plane polarization, circular polarization, elliptical polarization, or any other nonrandom polarization state in which the electric vector of the beam of light does not change direction randomly, but either maintains a constant orientation or varies in a systematic manner. In the plane polarization, the electric vector remains in a single plane, while in circular or elliptical polarization, the electric vector of the beam of light rotates in a systematic manner.

The term “retardation or retardance” refers to the difference between two orthogonal indices of refraction times the thickness of the optical element.

The term “in-plane retardation” refers to the product of the difference between two orthogonal in-plane indices of refraction times the thickness of the optical element.

The term “out-of-plane retardation” refers to the product of the difference of the index of refraction along the thickness direction (z direction) of the optical element minus one in-plane index of refraction times the thickness of the optical element. Alternatively, this term refers to the product of the difference of the index of refraction along the thickness direction (z direction) of the optical element minus the average of two orthogonal in-plane indices of refraction times the thickness of the optical element. It is understood that the sign—positive or negative—of the out-of-plane retardation is important to the user. But for purposes of simplicity, only the absolute value of the out-of-plane retardation will be reported herein. It is understood that one skilled in the art will know when to use an optical element with positive or negative out-of-plane retardation. For example, it is generally understood that an oriented film comprising triacetyl cellulose will produce a negative C-plate when the in-plane indices of refraction are substantially equal and the index of refraction in the thickness direction is less than the in-plane indices. However, herein, the value of the out-of-plane retardation will be reported as a positive number.

The term “substantially non-absorbing” refers to the level of transmission of the optical element of at least 80 percent transmissive with respect to at least one polarization state of visible light, where the percent transmission is normalized to the intensity of the incident, optionally polarized light.

The term “substantially non-scattering” refers to the level of collimated or nearly collimated incident light that is transmitted through the optical element being at least 80 percent transmissive for at least one polarization state of visible light within a cone angle of less than 30 degrees.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

Weight percent, percent by weight, % by weight, and the like are synonyms that refer to the concentration of a substance as the weight of that substance divided by the weight of the composition and multiplied by 100.

The recitation of numerical ranges by endpoints includes all numbers subsumed within that range (e.g. 1 to 5 includes 1, 1.5, 2, 2.75, 3, 3.80, 4, and 5).

As used in this specification and the appended claims, the singular forms “a,” “an,” and “the” include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly dictates otherwise.

### Examples of Backlight Stacks Utilizing Refractive Index Matching Interlayers

As already discussed above, the problem of RI mismatch between elements and layers of backlights stacks can be solved by introducing one or more buffer interlayers in between elements having such distinctive refractive indexes. The buffer interlayer, which is also referred to as a RI matching layer, may be based on polymer solutions discussed herein (although it may be based on other materials) and may have a specific RI and a specific retardation based on a specific thickness. The RI value of this buffer interlayer can be predetermined and selected in between the RIs of corresponding neighbor layers. For example, the RI value of a RI matching layer may include an average value of the RI values of adjacent layers, including air gaps as adjacent layers. It has been demonstrated that the RI matching layer may provide index matching for elements of a backlight unit stack and reduce various unwanted light losses, light reflections, scattering, and/or reflections at the layer boundaries. In certain embodiments, the polymers of the present disclosure may have in-plane (i.e., XY plane) retardation approaching zero, which make them very effective for the purposes of index matching and reducing light losses of various kinds and nature.

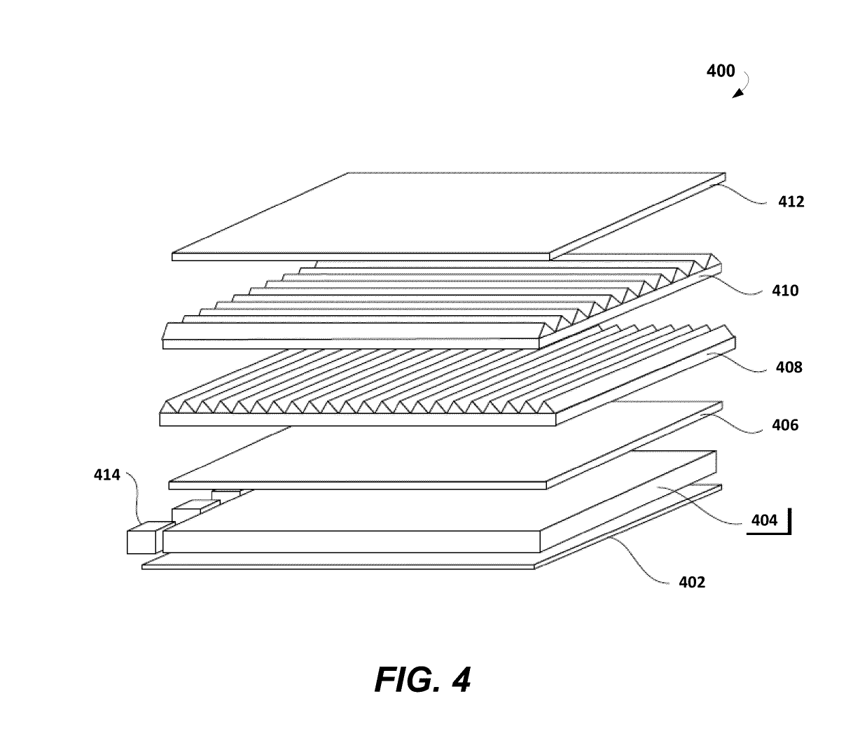

FIG. 4 is an expanded view of a backlight unit 400, in accordance with some embodiments. Backlight unit 400 may include a reflector 402, a light guide 404 disposed on the reflector 402, a course diffuser 406 disposed on the light guide 404, a BEF 408 disposed on the course diffuser 406, an additional BEF 410 disposed on BEF 408, and a fine diffuser 412 disposed on the additional BEF 410. It should be noted that the reflector 402, the light guide 404, the course diffuser 406, the BEF 408, the additional BEF 410, and the fine diffuser 412 can be combined in a different order. In some embodiments, backlight unit 400 includes other components or fewer components or multiple component functions combined within one component. For example, backlight unit 400 may not have an additional BEF 410 disposed between the BEF 408 and the fine diffuser 412. As a further example, the prism structure of BEF 408 may be incorporated in the design of the front surface of light guide 404, eliminating the need for BEF 408 as a separate component. The fine diffuser 412 is disposed adjacent to a polarizer stack (not shown) of the LCD.

The reflector 402 includes an aluminized substrate, a Titanium Dioxide coated substrate, a glass, a polyolefin, a polycarbonate, a polyamide, a polyimide, a cycloolefin polymer, a cycloolefin copolymer, a polyacryl, polystyrene, a polyethylene terephthalate (PET) based material or a triacetyl cellulose (TAC) based material. In some embodiments, backlight unit 400 may not have a reflector and a cladding layer of the light guide may function as a reflector. The light guide 404, the course diffuser 406, the fine diffuser 412, the brightness enhancing film 408 and the additional brightness enhancing film 410 include poly-methyl methacrylate (PMMA), poly carbonate (PC), PET, poly butylenes terephtalate (PBT), or poly ethylene (PE), or combinations thereof.

The difference between course diffuser 406 and fine diffuser 412 is in the scattering angle used by these diffusers. Sometimes, these scattering angles are referred to as diffusing angles. Course diffuser 406 has a scattering angle larger than that of fine diffuser 412. The purpose of course diffuser 406 and fine diffuser 412 is to homogenize the light throughout the entire surface. In the case of fine diffuser 412, it has the additional task of homogenizing the BEF structures. If this were not done, the structure of the BEF prisms would be superimposed on the image created by the LCD panel.

Light guide 404 may include a set of light sources 414 disposed along one or more edges of light guide 404. Some examples of light sources include cold cathode fluorescent (CCFL) devices and light emitting diode (LED) devices. However, other types of light sources may be used as well. As noted above, the edge orientation of light sources 414 reduces the overall thickness of the display in comparison to direct backlighted architectures, the so-called behind-the-stack orientation of light sources. Some light sources, such as LED devices have very wide angular distribution of light within the X-Y plane, such as +/−60° in some cases. In some embodiments, LEDs do not have any plastic lens and may be viewed as Lambertian illuminators, which are equally bright in every direction. Light guide 404 should be configured to accept most of the light. One approach is for light guide 404 to have a certain thickness at least at its light source edge. Another approach is to provide small light sources, such as quantum dots that, in some embodiments, can be incorporated into the light source edge of the light guide. Yet another approach is to form one or more optical lenses between the light source edge of the light guide and the light sources. For example, a cladding layer may be extended beyond the light source edge and the extended portion may be formed on one or more lenses. In other embodiments, these lenses may include standalone components.

Light guide 404 may also propagate the light away from light sources 414. In the example shown in FIG. 4, light sources 414 extend in the X direction along the edge of light guide 404. In some embodiments, light sources may extend along two or more edges, such as two opposite edges of light guide. Light guide 404 may also redirect the light along the Z direction to the viewer and to the reflector. Uniform illumination across the entire display area (defined by the X and Y axes) and luminance sufficient to produce a bright image in an operating environment of the display are two of many considerations in the design of light guide 404. When a reflector is present in a unit, light guide 404 may also divert some light down to the reflector. The reflector may then redirect some light back toward the back light unit for use in the display.

In a conventional backlight unit, a light guide is a single component, such as a sheet of poly methyl methacrylate (PMMA) having a refractive index of about 1.5, or polycarbonate (PC), having an index of refraction of about 1.58. A light guide has a set of light extracting features, which may be parts of the light guide or standalone features added onto the light guide. For example, an array of white dots may be printed on one side of this light guide to create light scattering to change the direction of the light and to allow the light to escape the light guide. In another example, one or both surfaces of a light guide may be embossed or processed with some groove-type or other structures with features protruding upwards or downward. However, every reflection and scattering of the light can cause some losses of light energy in the viewing direction. Such reflection and scattering can come from various sources and causes within individual backlight components due to material variations and manufacturing imperfections.

Furthermore, a conventional light guide interfaces air, which has a refractive index of 1. The Snell law presented below governs the relationship between refractive indices of two components forming an interface and the angle at which the light reflects from this interface or escapes through the interface. For containing the light within the light guide it is desirable to have a refractive index of the outermost component as high as possible.

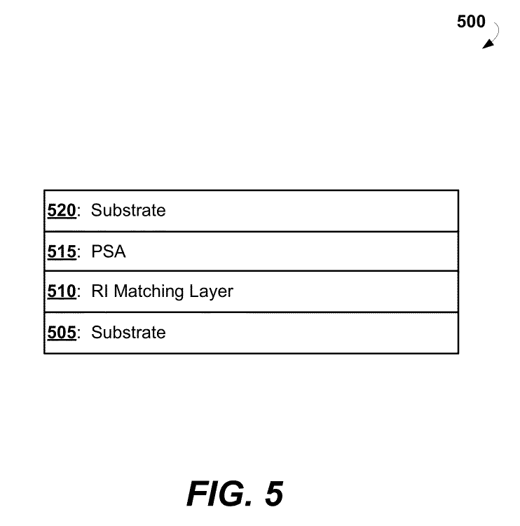

FIG. 5 is a high level drawing of a backlight unit 500 comprising two adjacent components shown as a substrate 505 and a substrate 520. The substrates 505, 520 include a reflector, a light guide, a course diffuser, a brightness enhancing film, a further brightness enhancing film, and a fine diffuser.

To reduce light losses in a backlight unit, enhance light containment characteristics, and streamline fabrication of these units, the backlight unit may comprise one or more RI matching layers deposited onto one or more components of the backlight unit. In particular, the RI matching layer may be deposited onto the reflector, the light guide, the course diffuser, the brightness enhancing film, the additional brightness enhancing film and the fine diffuser. As shown on FIG. 5, a front surface of the substrate 505 receives a RI matching layer 510.

The refractive index of RI matching layers may be an average value of refractive indexes of adjacent or neighboring layers. In particular, the refractive index of the RI matching layer deposited onto the reflector is designed to enable functioning of the reflector and minimize reflections at the reflector-air gap boundary or the reflector—PSA boundary. As shown on FIG. 5, two substrates 505, 520 are joined with an index matching PSA 515. The PSA refractive index can match the index of the uncoated rear side of the light guide or be slightly less. Similarly, the refractive index of the RI matching layer deposited over the light guide is designed to enable functioning of the light guide and minimize reflections at the light guide-air gap boundary or the light guide-PSA boundary. The PSA index can match the index of the uncoated rear side of the coarse diffuser or be slightly less. The refractive index of the RI matching layer deposited over the course diffuser is designed to enable functioning of the coarse diffuser and minimize reflections at the coarse diffuser-air gap boundary or the coarse diffuser-PSA boundary. The PSA index can match in the index of the uncoated rear side of the first BEF or be slightly less. Similarly, the refractive index of the RI matching layer deposited over the brightness enhancing film is designed to enable functioning of the BEF and minimize reflections at the BEF-air gap boundary or the BEF-PSA boundary. The PSA index can match the index of the uncoated rear side of the second BEF or the uncoated read side of the fine diffuser or be slightly less The refractive index of the RI matching layer deposited onto the additional brightness enhancing film is designed to enable the functioning of the BEF and minimize reflections at the BEF-air gap boundary or the BEF-PSA boundary. The PSA index can match the index of the uncoated rear side of the fine diffuser or be slightly less. The refractive index of the RI matching layer deposited over the fine diffuser is designed to enable the functioning of the fine diffusers and minimize reflections at the fine diffuser-air gap boundary or the fine diffuser PSA boundary. The PSA index can match the index of uncoated rear side first film in the rear polarizer stack or be slightly less.

Additionally, the RI matching layers may provide light collimation. Whenever light is transmitted via the boundary of two media with different refractive indexes, some light is reflected back into the media the light was originally passing through, and some is refracted into the media it was originally traveling towards. Light collimation makes incidence angles at the boundaries smaller and, thus, amount of light reflected back decreases. Ideally, light should propagate normally to the surface of key layers. That said, introduction of RI matching layer(s) based on polymers disclosed herein possessing predetermined refractive indexes may facilitate light propagation through all layers constituting backlight stacks.

To further reduce light losses in a backlight unit, enhance light containment characteristics, and streamline fabrication of these units, the backlight unit may comprise one or more PSAs deposited onto the one or more RI matching layers. In all instances the PSA will be deposited onto a high index RI matching layer and the PSAs opposite side will be deposed on an uncoated substrate. The index of the PSA shall be less than the index of the high index RI matching layer. The index of the PSA shall be substantially equal to the index of the uncoated substrate. Light passing through the high index-PSA boundary will refract away from the normal to the boundary. However, given that the index of the PSA is significantly higher than the index of air, the net effect of this optical architecture is an increase in light collimation and reduced reflections at the boundary. The substrate layer includes the reflector, the light guide, the course diffuser, the brightness enhancing film, and the fine diffuser.

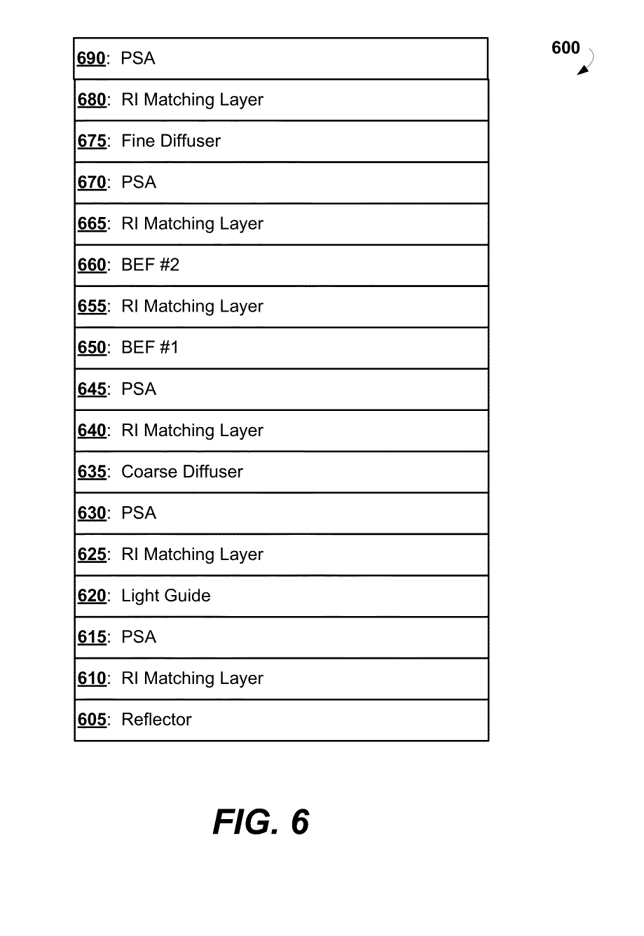

FIG. 6 is a detailed diagram of a backlight unit, in which a front surface of each component receives a high index of refraction coating and adjacent components are joined with an index matching PSA. The multilayer stack 600 of the backlight unit consists of multiple layers including a reflector 605, a light guide 620, a coarse diffuser 635, a BEF #1 650, a BEF #2 660, and a fine diffuser 675. The multilayer stack 600 further comprises multiple RI matching layers, in particular the RI matching layer 610 deposited on the reflector 605, the RI matching layer 625 deposited onto the light guide 620, the RI matching layer 640 deposited onto the coarse diffuser 635, the RI matching layer 655 deposited onto the BEF #1 650, the RI matching layer 665 deposited onto the BEF #2 660, and the RI matching layer 680 deposited on the fine diffuser 675.

Furthermore, the multilayer stack 600 includes multiple PSAs deposited onto the one or more refractive index matching layers. In particular, the multilayer stack 600 comprises a PSA 615 disposed on the refractive index matching layer 610 between the reflector 605 and light guide 620, a PSA 630 disposed on the refractive index matching layer 625 between the light guide 620 and the coarse diffuser 635, a PSA 645 disposed on the refractive index matching layer 640 between the coarse diffuser 635 and the BEF #1 650, a PSA 670 disposed on the refractive index matching layer 665 between the BEF#2 660 and the fine diffuser 675, and a PSA 690 disposed on the refractive index matching layer 680 between the fine diffuser 675 and a rear polarizer stack (not shown) of the LCD.

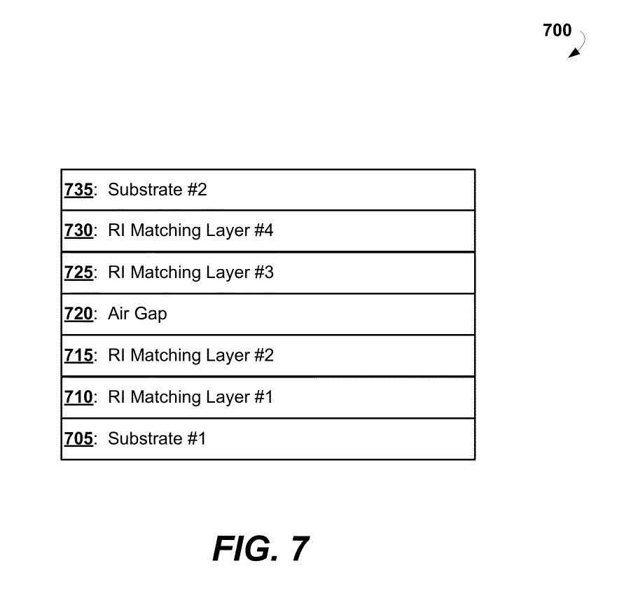

FIG. 7 is a high level diagram of a backlight unit 700 having two adjacent components shown as substrate #1 705 and substrate #2 735, where the front and rear surfaces of the adjacent substrates each receive a complex multilayer coating of at least two layers and the adjacent components have an air gap between them. The substrates 705, 735 include a reflector, a light guide, a course diffuser, a brightness enhancing film, a further brightness enhancing film, and a fine diffuser. Two RI matching layers 710, 715 are deposited onto a front surface of the substrate 705. Two RI matching layers 730, 725 are deposited onto a rear surface of the substrate 735 faced towards the front surface of the substrate 705 onto which RI matching layers 710, 715 are deposited. The substrates 705, 735 are disposed in such a way that an air gap 720 is present between the substrates 705, 735, specifically between the RI matching layer 715 and RI matching layer 725. In the case of multilayer coatings, such as RI matching layers 710, 715, used with an air gap, the refractive index of the coating may be less than the refractive index of the substrate. The complex multilayer coatings are based on both index matching and constructive and destructive interference controlled by coating thickness. The complex multilayer coatings reduce light losses due to reflections and scattering.

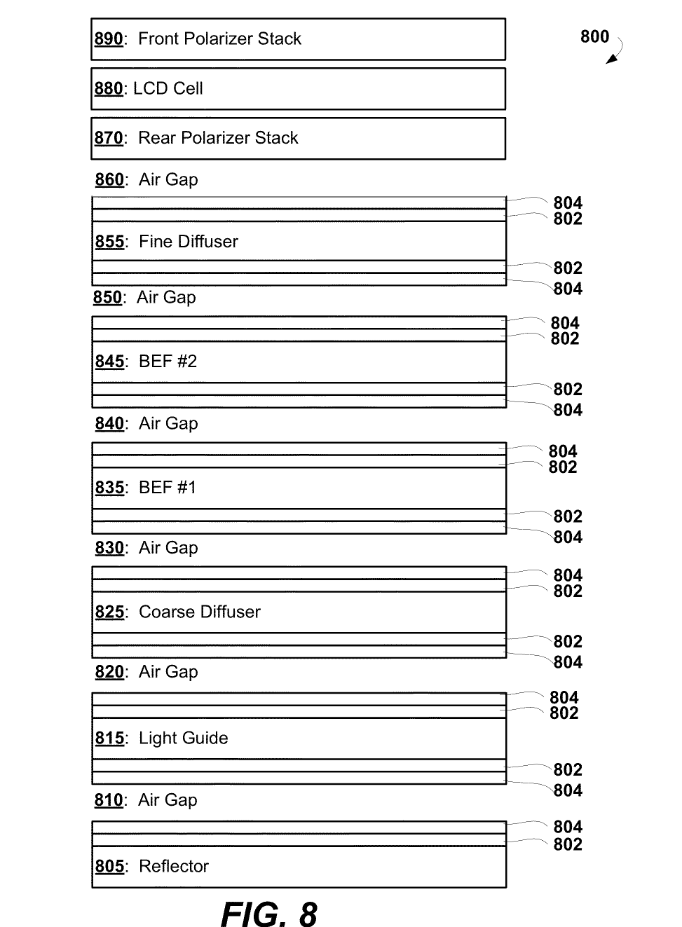

FIG. 8 is a detailed diagram of a backlight unit 800 with the front and rear surfaces of each component receiving a complex multilayer coating of at least two layers and adjacent components have an air gap between them.

The backlight unit 800 consists of multiple layers including a reflector 805, a light guide 815, an air gap 810 between the reflector 805 and light guide 815, a coarse diffuser 825, an air gap 820 between the light guide 815 and coarse diffuser 825, a BEF #1 835, an air gap 830 between the coarse diffuser 825 and the BEF #1 835, an air gap 840 between the BEF #1 835 and the BEF #2 845, a fine diffuser 855, an air gap 850 between the BEF#2 845 and the fine diffuser 855, the rear polarizer stack 870, and air gap 860 between the fine diffuser 855 and the rear polarizer stack 870, an LCD cell 880, and a front polarizer stack 890. The front surface of the reflector 805 receives at least two RI matching layers 802, 804 forming a complex multilayer coating. The front and rear surfaces of each of the light guide 815, the coarse diffuser 825, the BEF #1 835, the BEF #2 845, and the fine diffuser 855 receive at least two RI matching layers 802, 804. The adjacent elements of the backlight unit 800 are joined with the air gaps 810, 820, 830, 840, 850, 860 between the RI matching layers 804 of each two adjacent elements. It should be noted that the reflector 805, the light guide 815, the course diffuser 825, the BEF #1 835, the BEF #2 845, and the fine diffuser 855 can be combined in a different order. In an example embodiment, the backlight unit 800 further comprises PSAs (not shown) deposited onto the two or more RI matching layers 802, 804. The complex multilayer coating formed by the RI matching layers 802, 804 relies on interference between waves reflecting off multiple surfaces and reduces losses due to reflections and scattering.

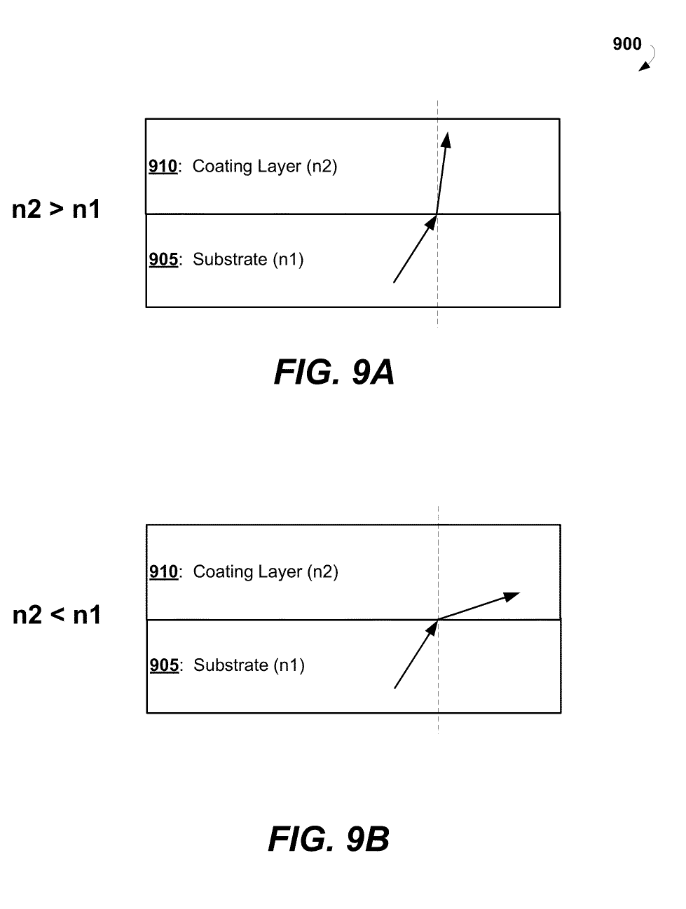

FIGS. 9A and 9B show a block diagram of an example backlight stack 900 employing a substrate and one coating matching layer. FIG. 9A illustrates an example in which a refractive index of the coating RI matching layer 910 is higher than the refractive index of the substrate 905. FIG. 9B illustrates an example in which the refractive index of the substrate 905 is higher than the refractive index of the second RI matching layer 910. As can be seen in FIG. 9A, light traveling through the substrate 905 to coating 910 boundary refracts toward the normal, in effect collimating the light. In FIG. 9B, the light traveling through the substrate 905 to coating 910 boundary refracts away from the normal, in effect dispersing the light over a wider solid angle. FIG. 9A is analogous to a substrate coated with a high index coating. FIG. 5B is analogous to an air gap over an uncoated substrate.

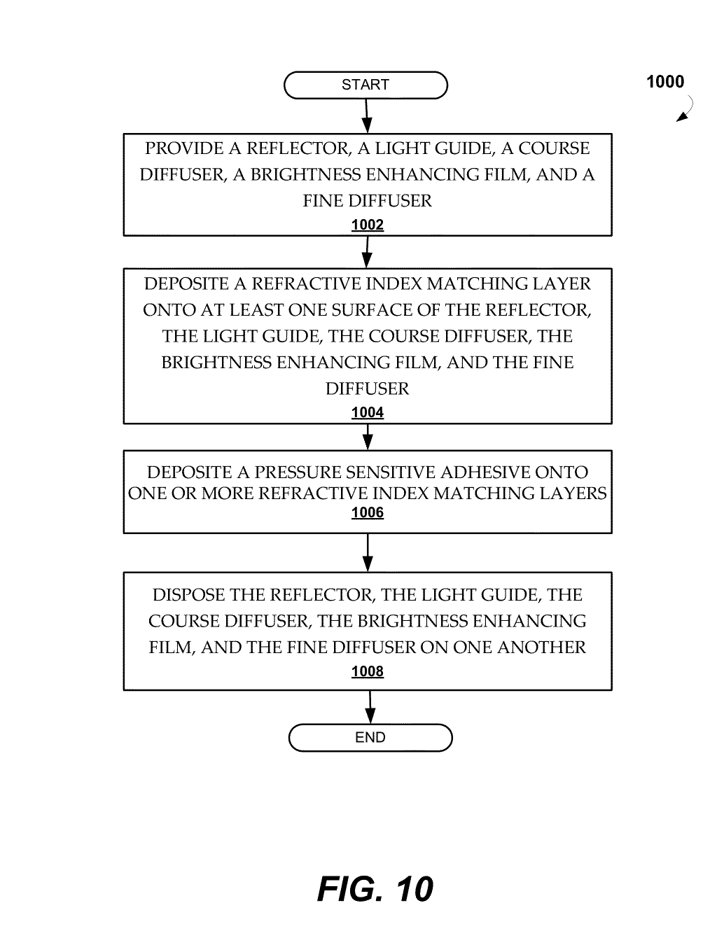

FIG. 10 is a flow chart illustrating a method 1000 for forming a multilayer stack for reducing light losses in a liquid crystal display (LCD) backlight, an LCD rear polarizer stack, an LCD panel, and a front polarizer stack. The method 1000 may commence with operation 1002, at which a reflector, a light guide, a course diffuser, a brightness enhancing film, and a fine diffuser are provided. Optionally, an additional brightness enhancing film can be provided. The reflector may include an aluminized substrate, a Titanium Dioxide coated substrate, a glass, a polyolefin, a polycarbonate, a polyamide, a polyimide, a cycloolefin polymer, a cycloolefin copolymer, a polyacryl, polystyrene, a polyethylene terephthalate (PET) based material or a triacetyl cellulose (TAC) based material. In place of an aluminized or Titanium Dioxide coated substrate, a white substrate may be substituted. The light guide, the course diffuser, the fine diffuser, the brightness enhancing film, and the additional brightness enhancing film include poly-methyl methacrylate (PMMA), poly carbonate (PC), PET, poly butylenes terephtalate (PBT), or poly ethylene (PE), or combinations thereof.

After providing the elements of the multilayer stack, an RI matching layer is deposited onto one surface of the reflector, and onto at least one surface of the light guide, the course diffuser, the brightness enhancing film, and the fine diffuser at operation 1004. The RI matching layer is also deposited onto one surface of the optional additional brightness enhancing film, if present. The refractive index of RI matching layers should be higher than the index of the substrate layer. In particular, the refractive index of the RI matching layer deposited onto the reflector is higher than the refractive index of the reflector. Similarly, the refractive index of the RI matching layer deposited over the light guide should be higher than the refractive index of the light guide. The refractive index of the RI matching layer deposited over the course diffuser is higher than the refractive index of the course diffuser. Similarly, the refractive index of the RI matching layer deposited over the brightness enhancing film is higher than the refractive index of the brightness enhancing film. The refractive index of the RI matching layer deposited onto the additional brightness enhancing film is higher than the refractive index of the additional brightness enhancing film. The refractive index of the RI matching layer deposited over the fine diffuser is higher than the refractive index of the fine diffuser. In an example embodiment, the method may comprise depositing one or more additional RI matching layers onto one or more RI matching layers. The RI matching layer is deposited using one or more of the following techniques: slot die extrusion, Mayer rod coating, roll coating, gravure coating, micro-gravure coating, comma coating, knife coating, extrusion, printing, spray coating, and dip coating.

After deposition of the RI matching layer, a PSA is disposed onto one or more RI matching layers at operation 1006. The PSA is also deposited onto the optional additional brightness enhancing film, if present. The refractive index of each of the PSA is substantially equal to a refractive index of the uncoated surface onto which it is deposed and in any event is always less than the index of refraction of the high index coating on its opposite side. The elements onto which the PSA is deposited includes the reflector, the light guide, the course diffuser, the brightness enhancing film, and the fine diffuser

After deposition of the PSA, the reflector, the light guide, the course diffuser, the brightness enhancing film, and the fine diffuser are deposited at operation 1008. In an example embodiment, the light guide is disposed on the reflector. Furthermore, the course diffuser is disposed on the light guide. The brightness enhancing film is disposed on the course diffuser. The fine diffuser is disposed on the brightness enhancing film. The fine diffuser is disposed adjacent to the rear polarizer stack of the LCD.

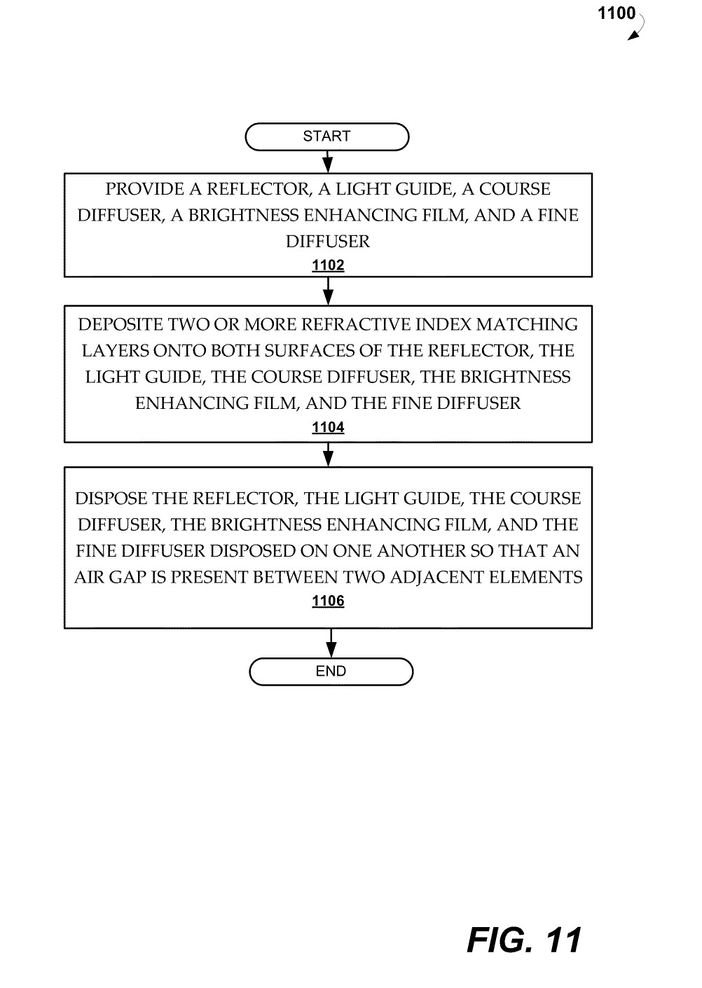

FIG. 11 is a flow chart illustrating a method 1100 for forming a multilayer stack for reducing light losses in a liquid crystal display (LCD) backlight, an LCD rear polarizer stack, an LCD panel, and a front polarizer stack. The method 1100 may commence with operation 1102, at which a reflector, a light guide, a course diffuser, a brightness enhancing film, and a fine diffuser are provided. Optionally, an additional brightness enhancing film can be provided. The reflector may include an aluminized substrate, a Titanium Dioxide coated substrate, a glass, a polyolefin, a polycarbonate, a polyamide, a polyimide, a cycloolefin polymer, a cycloolefin copolymer, a polyacryl, polystyrene, a polyethylene terephthalate (PET) based material or a triacetyl cellulose (TAC) based material. In place of an aluminized or Titanium Dioxide coated substrate, a white substrate may be used. The light guide, the course diffuser, the fine diffuser, the brightness enhancing film, and the additional brightness enhancing film include poly-methyl methacrylate (PMMA), poly carbonate (PC), PET, poly butylenes terephtalate (PBT), or poly ethylene (PE), or combinations thereof.

After providing the elements of the multilayer stack, two or more RI matching layer are deposited onto both surfaces of at least one of the reflector, the light guide, the course diffuser, the brightness enhancing film, and the fine diffuser at operation 1104. Two or more refractive index matching layers are also deposited onto both surfaces of the additional brightness enhancing film. Each of the two or more RI matching layers forms a complex layer configured to reduce light losses due to reflections and scattering relative to the losses due to reflections and scattering at the boundary of an uncoated component and the air gap. There is both constructive interference of the light rays and destructive interference of the light rays in the two or more RI matching layers. In all cases, the thickness of these layers must be controlled.

After deposit of the RI matching layer at operation 1106, the reflector, the light guide, the course diffuser, the brightness enhancing film, and the fine diffuser are disposed on one another so that an air gap is present between two adjacent elements. In an example embodiment, the light guide is disposed on the reflector so that an air gap is present between the light guide and the reflector. After disposing the light guide, the course diffuser is disposed on the light guide so that an air gap is present between the course diffuser and the light guide. Furthermore, the brightness enhancing film is disposed on the course diffuser so that an air gap is present between the brightness enhancing film and the course diffuser. The fine diffuser is disposed on the brightness enhancing film so that an air gap is present between the fine diffuser and the brightness enhancing film. Optionally, the additional brightness enhancing film is disposed between the brightness enhancing film and the fine diffuser so that an air gap is present between the brightness enhancing film and the additional brightness enhancing film. The fine diffuser is disposed adjacent to the rear polarizer stack of the LCD so that an air gap is present between the fine diffuser and the rear polarizer stack.

### Examples of Polymers Applicable for the Use in Refractive Index Matching Interlayers

The RI matching layers may be based on various organic or inorganic polymer solutions. One example of such polymer solution may include a chain of n subunits, where each subunit has a general structure formula (I) as follows:

[-(Core(S)ₘ)ₖ-Gₗ-]ₙ (I)

The organic units comprise rigid conjugated organic component Core, where G is a spacer selected from the list comprising —C(O)—NR1-, ═(C(O))2=N—, —O—NR1-, linear and branched (C1-C4) alkylenes, —CR1R2—O—C(O)—CR1R2-, —C(O)—O—, —O—, —NR1-. R1 and R2 are independently selected from the list comprising H, alkyl, alkenyl, alkynyl, aryl. S are lyophilic side-groups providing solubility to the polymer in the solvent and which are the same or different and independently selected from the list comprising one or more of the following: —COOX, —SO3X. X is selected from the list comprising H, alkyl, alkenyl, alkynyl, aryl, alkali metal, NW4. W is H or alkyl or any combination thereof, —SO2NP1P2 and —CONP1P2. P1 and P2 are independently selected from the list comprising H, alkyl, alkenyl, alkynyl, aryl; and wherein m is 0, 1, 2, or 3, and k is 1, 2, or 3.

The number n of subunits may be between about 5 and 50,000 or, more specifically, between 10 and 10,000. Those skilled in the art should understand that the number of subunits may define physical properties of optical elements based thereupon. For example, when the number of subunits is relatively small, the corresponding polymer chains may be too short to achieve a desired orientation. On the other hand, when the number of subunits is relatively high, the corresponding polymer chains may be too long and cause high viscosity and poor dissolving qualities associated of the polymer. In this regard, the number of subunits and the corresponding chain length may depend on selected organic components (Core), spacers (G), side-groups (S), desired orientation, and particular application.

In various embodiments, the organic components core provide linearity and rigidity of the macromolecule associated with the organic polymer compound having formula (I). The sets of lyophilic side groups (Sₘ) and the number of the organic units n may control a ratio between mesogenic properties and viscosity of the polymer solution. The selection of organic components (Core), the lyophilic side-groups (S) and number of organic subunits n may determine the type and birefringence of the optical film.

In some embodiments, most of the organic units (e.g., more than 90%, more than 95%, or more than 99%) of the polymer are the same. However, in some embodiments, at least one organic subunit is different so that a copolymer may be formed.

Each subunit may include at least four conjugated organic components Core capable of forming a rigid rod-like macromolecule. These conjugated components may be individually selected from the following list of structural formulas (II) to (X):

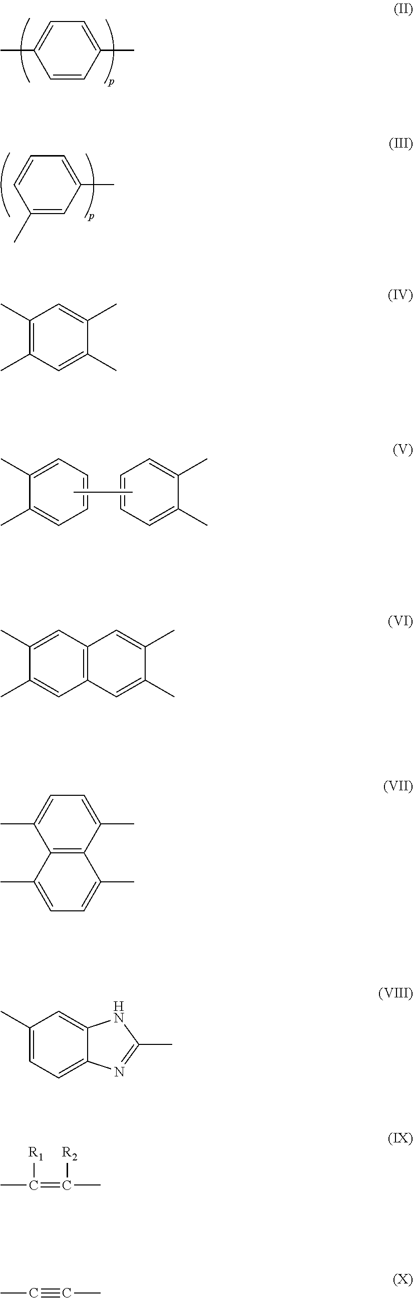

where p is an integer equal to 1, 2, 3, 4, 5, or 6; and where R₁, R₂=H, alkyl. It should be noted that components (II)-(X) may provide linearity and rigidity for the macromolecule while varying in structure.

In certain embodiments, organic components (Core) in each subunit may be of the same type. Alternatively, each organic subunit may include a Core of different type, which, in turn, may alter optical properties of optical elements including such polymer compound. Those skilled in the art should understand that combining the organic components in subunits may affect specific optical properties for the optical element.

Further, each subunit may also include one or more spacer (G). Some examples of spacers include —C(O)—NR1-, ═(C(O))2=N—, —O—NR1-, linear and branched (C1-C4) alkylenes, —CR1R2-O—C(O)—CR1R2-, —C(O)—O—, —O—, —NR1-, where R1 and R2 are independently selected from the list comprising H, alkyl, alkenyl, alkynyl, and aryl.

Further, each subunit may also include one or more lyophilic side-groups (S), which may include lyophilic groups providing solubility to the polymer or its salts in a suitable solvent. In some embodiments, one or more side groups may be hydrophilic groups, such as —COOX, —SO3X, wherein X is selected from the list comprising H, alkyl, alkenyl, alkynyl, aryl, alkali metal, NW4, wherein W is H or alkyl or any combination thereof, and —SO2NP1P2 and —CONP1P2, where P1 and P2 are independently selected from the list comprising H, alkyl, alkenyl, alkynyl, aryl. In the formula (I), the total number of the side groups (m) is 0, 1, 2, or 3.

In various embodiments, said n organic units may include one or more termination components connecting to these n organic units according the following principle:

T-[-(Core(S)ₘ)ₖ-Gₗ-]ₙ-T

where T includes one or more of alkenyl, alkynyl, acrylic, or any other UV-curable group.

A number of side groups as well as the number of organic units n may control the ratio between mesogenic properties and viscosity of the polymer. The selection of organic components (Core), the side-groups (S), and number of organic units (i.e., the value of n) determines the type and birefringence of the polymers and corresponding optical element based on the polymers. These polymers may be capable of forming solid optical retardation layers, such as a positive A-type retardation layer, a negative C-type retardation layer, or a Ba-type retardation layer, based on orientation or disorientation of the polymers and its components. For example, the conjugated component having formula (II) is linear in general, but the conjugated component having the formula (III) is disordered in general. Accordingly, if the subunit includes the conjugated components (II) only, the resulting polymer may have a negative C-type retardation layer. However, once the conjugated components (II) and (III) are combined in subunits, the resulting polymer may have an Ba-type retardation layer.

Molecules have to be rigid and long enough in order to provide ordering during drying. However, both of these factors for polymers in aqueous solutions may lead to tendency of LLC (lyotropic liquid crystal) formation. This effect is undesirable for one who wants to produce a negative C-plate. In order to suppress LLC formation, certain groups are added to decrease mesogenic properties, such as the following (but not limited to):

(a) introduction of chain-distorting (non-linear) fragments

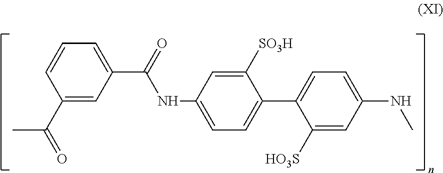

or the following:

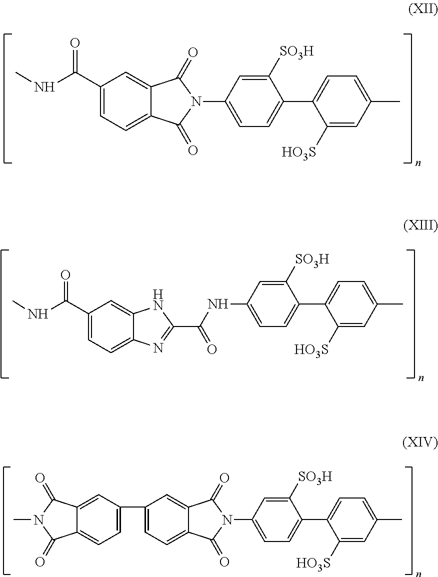

(b) introduction of large fragments, which sterically hinder interaction between chains:

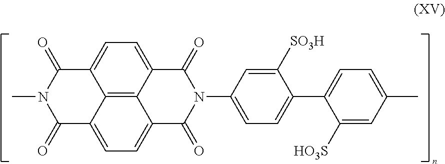

(c) introduction of side-groups, which sterically hinder interaction between chains:

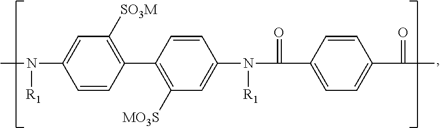

In some embodiments, a polymer may have specific number of organic compounds and spacers. In other words, a monomer subunit forming the polymer may include, for example, two organic components, one of which has no side groups, while the other has two side groups. The first organic component (Core) may be represented by any of the formulas above, i.e., II (where p=1), III (where p=1), V, VII and VIII. The second organic component (Core) may be represented by the general formula II (where p=2). The side-group (S) may include sulfo-group SO₃H. The first spacer (G) may include C(O)—NH— or =2(C(O))═N—, while the second spacer (G) may include one of —C(O)—, —NH—C(O)—, —N═(C(O))2=. Examples of these subunits or polymers may incude: poly(2,2′-disulfo-4,4′-benzidine terephthalamide), poly(2,2′-disulfo-4,4′-benzidine isophthalamide), poly(2,2′-disulfo-4,4′-benzidine 1,3-dioxo-isoindoline-5-carboxamide), poly(2,2′-disulfo-4,4′-benzidine 1H-benzimidazole-2,5-dicarboxamide), poly(2,2′-disulfo-4,4′-benzidine 3,3′,4,4′-biphenyl tetracarboxylic acid diimide), and poly(2,2′disulpho-4,4′benzidine 1,4,5,8-naphtalen tetracarboxylic acid diimide). The corresponding structural formulas (XVI)-(XXI) of these subunits are shown below:

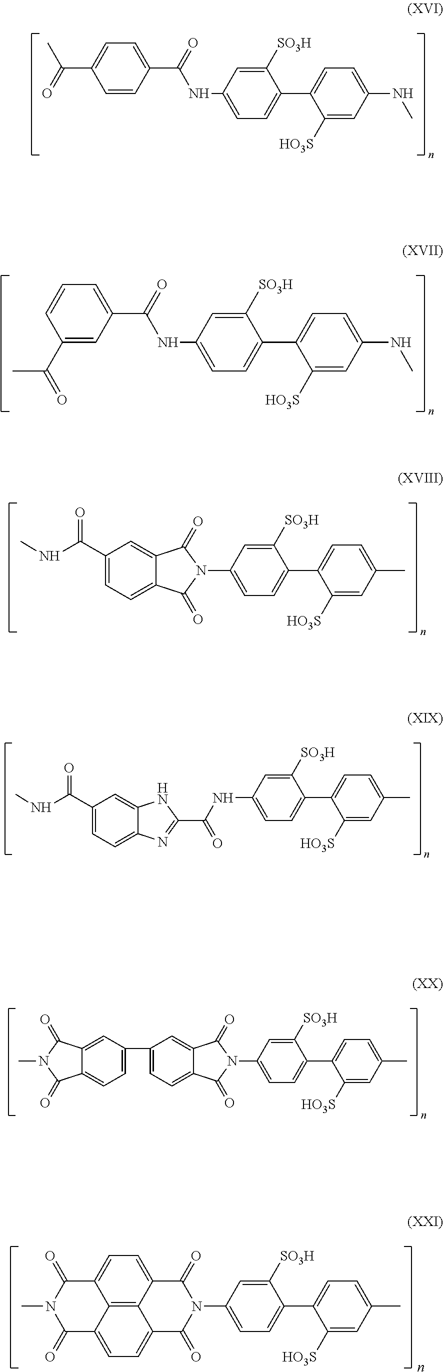

where the number n of subunits may be between about 5 and 500,000.

In yet other embodiments, rigid rod-like macromolecules may be synthesized with n organic subunits of a first type and k organic subunits of a second type. In particular, the first type of organic subunits may include the following general structural formula:

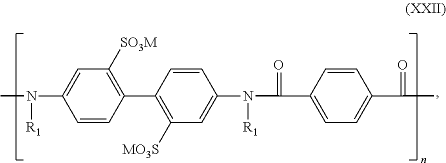

while the second type of organic subunits may include the following general structural formula:

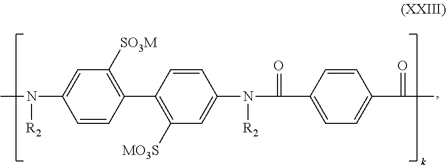

wherein n maybe in the range of 5 to 10,000, and k may be in the range of 5 to 10,000. R₁ and R₂ are side-groups that may be independently selected from the list comprising —H⁺, alkyl, —(CH₂)ₘSO₃M, —(CH₂)ₘSi(O-alkyl)₃, —CH₂-aryl, —(CH₂)ₘOH, where m may include a number from 1 to 18, and in the case of H⁺ as one of the side-groups, the total number of H⁺ should not exceed 50% of total number of side-groups (R₁ and R₂) in the macromolecule. M is counterion selected from the list comprising H⁺, Na⁺, K⁺, Li⁺, Cs⁺, Ba²⁺, Ca²⁺, Mg²⁺, Sr²⁺, Pb²⁺, Zn²⁺, La³⁺, Al³⁺, Bi³⁺, Ce³⁺, Y³⁺, Yb³⁺, Gd³⁺, Zr⁴⁺ and NH₄₋ₚQₚ⁺, where Q is selected from the list comprising linear and branched (C1-C20) alkyl, (C2-C20) alkenyl, (C2-C20) alkynyl, and (C6-C20) arylalkyl, and p is 0, 1, 2, 3 or 4. The organic units of the first type and the organic units of the second type are contained in the rigid rod-like macromolecules in an arbitrary sequence and may comprise polymerization of at least one aromatic diamine monomer having, for example, the following structural formula:

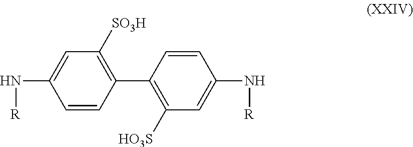

where R is a side-group that is independently selected for different monomers from the list comprising —H⁺, alkyl, —(CH₂)ₘSO₃M, —(CH₂)ₘSi(O-alkyl)₃, —CH₂-aryl, and —(CH₂)ₘOH, wherein m is a number from 1 to 18, and at least one difunctional electrophile monomer may have, for example, the following structural formula:

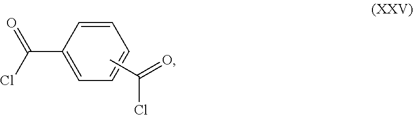

an acid acceptor, and at least two solvents, wherein one solvent is water and another solvent is a water-immiscible organic solvent, and wherein an optimal pH of the polymerization step is approximately between 7 and 10.

In various embodiments, one or more salts of the organic polymer solution may be used, such as alkaline metal salts, ammonium, alkyl-substituted ammonium salts, alkenyl-substituted ammonium salts, alkynyl-substituted ammonium salts, and aryl-substituted ammonium salts. In various embodiments, the polymer may include one or more inorganic compounds such as hydroxides and salts of alkaline metals. Solvents used for dissolving polymers may include water, any organic solvent, or any combination thereof.

### Examples of Polymer Synthesizing

Reference is now made to the following examples, which are intended to be illustrative of various embodiments of the present disclosure, but are not intended to be limiting the scope.

### Example 1

This example describes synthesis of poly(2,2′-disulfo-4,4′-benzidine isophthalamide) cesium salt (i.e., structure (XII)):

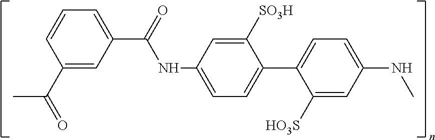

In particular, 1.377 g (0.004 mol) of 4,4′-diaminobiphenyl-2,2′-disulfonic acid was mixed with 1.2 g (0.008 mol) of Cesium hydroxide monohydrate and 40 ml of water and stirred with dispersing stirrer till dissolving, then 0.672 g (0.008 mol) of sodium bicarbonate was added to the solution and stirred. While stirring the obtained solution at high speed (2500 rpm), a solution of 0.812 g (0.004 mol) of isophthaloyl dichloride (IPC) in dried toluene (15 mL) was gradually added within 5 minutes. The stirring was continued for 5 more minutes, and viscous white emulsion was formed. Then the emulsion was diluted with 40 ml of water, and the stirring speed was reduced to 100 rpm. After the reaction mass has been homogenized, the polymer was precipitated by adding 250 ml of acetone. Fibrous sediment was filtered and dried.

Weight average molar mass of the polymer samples was determined by gel permeation chromatography (GPC) analysis of the sample was performed with a Hewlett Packard© (HP) 1050 chromatographic system. Eluent was monitored with diode array detector (DAD HP 1050 at 305 nm). The GPC measurements were performed with two columns TSKgel G5000 PWXL and G6000 PWXL in series (TOSOH Bioscience, Japan). The columns were thermostated at 40° C. The flow rate was 0.6 mL/min. Poly(sodium-p-styrenesulfonate) was used as GPC standard. Varian GPC software Cirrus 3.2 was used for calculation of calibration plot, weight-average molecular weight, Mw, number-average molecular weight, Mn, and polydispersity (D=Mw/Mn). The eluent was mixture of 0.1 M phosphate buffer (pH=7.0) and acetonitrile in the ratio 80/20, respectively. The Mw, Mn, and polydispersity (D) of polymer were 720 000, 80 000, and 9, respectively.

### Example 2

Example 2 describes synthesis of 2,2′-disulfo-4,4′-benzidine terephthalamide-isophthalamide copolymer cesium salt (copolymer of structures (XI) and (XII):

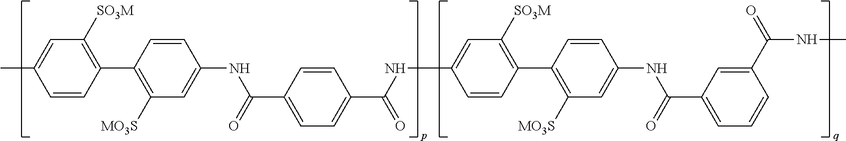

The same method of synthesis as in the Example 1 can be used for preparation of the copolymers of different molar ratio. In particular, 4.098 g (0.012 mol) of 4,4′-diaminobiphenyl-2,2′-disulfonic acid was mixed with 4.02 g (0.024 mol) of cesium hydroxide monohydrate in water (150 ml) in a 1 L beaker and stirred until the solid was completely dissolved. Then 3.91 g (0.012 mol) of sodium carbonate was added to the solution and stirred at room temperature until dissolved. Then toluene (25 ml) was added. Upon stirring the obtained solution at 7000 rpm, a solution of 2.41 g (0.012 mol) of terephthaloyl chloride (TPC) and 2.41 g (0.012 mol) of isophthaloyl chloride (IPC) in toluene (25 ml) were added. The resulting mixture thickened in about 3 minutes. The stirrer was stopped, 150 ml of ethanol was added, and the thickened mixture was crushed with the stirrer to form slurry suitable for filtration. The polymer was filtered and washed twice with 150-ml portions of 90% aqueous ethanol. Obtained polymer was dried at 75° C. The GPC molecular weight analysis of the sample was performed as described in Example 1.

### Example 3

Example 3 describes synthesis of poly(2,2′disulpho-4,4′ benzidine 1,4,5,8-naphtalen tetracarboxylic acid diimid) triethylammonium salt (i.e., the structure (XVI)):

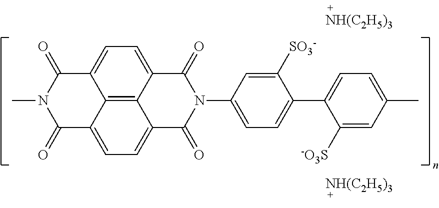

4.023 g (0.015 mol) of 1,4,5,8-naphtaline tetracarbonic acid dianhydride and 5.165 g (0.015 mol) of 2,2′-disulfobenzidine and 0.6 g of benzoic acid (catalyst) were charged into a three-neck flask equipped with an agitator and a capillary tube for argon purging. With argon flow turned on, 40 ml of molten phenol was added to the flask. Then the flask was placed in a water bath at 80° C., and the content was agitated until homogeneous mixture was obtained. 4.6 ml of triethylamine was added to the mixture, and agitation was kept on for 1 hour to yield solution. Then the temperature was raised successively to 100, 120, and 150° C. At 100 and 120° C., agitation was held for 1 hour at each temperature. During this procedure, the solution keeps on getting thicker. Time of agitation at 150° C. is 4 to 6 hours.

The thickened solution is diluted with liquid phenol (mixture of water/phenol=1/10 by volume), until a target consistency at 100° C. is obtained, and the resulting mixture is quenched with acetone. Weight average molar mass of the polymer samples was determined by GPC. The GPC analysis of the polymer samples was performed with a Hewlett Packard 1050 HPLC system and the diode array detector (A=380 nm). The chromatographic separation was done using OHpak SB-804 HQ column from Shodex. Mixture of dimethyl sulfoxide (DMSO) and dimethylformamide (DMF) in proportion of (75:25) respectively, with addition of 0.05M of lithium chloride (LiCl) was used as the mobile phase. Chromatographic data were collected and processed using the ChemStation B10.03 (Agilent Technologies) and GPC software Cirrus 3.2 (Varian). Poly(styrenesulfonic acid) sodium salt was used as a GPC standard. Before the GPC analysis, all samples of the analyzed polymer and the standards were dissolved in DMSO in the concentration of approximately 1 mg/mL.

### Example 4

Example 4 describes synthesis of poly(2,2′-disulfo-4,4′-benzidine 1,3-dioxo-isoindoline-5-carboxamide) cesium salt (i.e., the structure (XIII)).

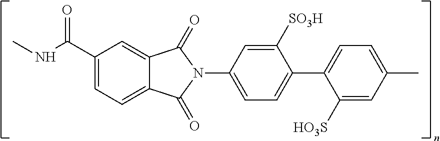

In particular, 2,5-Diaminobenzene-1,4-disulfonic acid (0.688 g, 2.0 mmol), anhydrous N-methylpyrrolidone (10 mL), triethylamine (0.86 mL) and trimellitic anhydride chloride (0.421 g, 2 mmol) were charged subsequently into a two-neck flask equipped with a magnetic stirrer, thermometer, and air condenser with argon inlet. The reaction mixture was then heated up to approximately 130-140° C. and stirred for 24 hours. Then the reaction mixture was cooled to room temperature, and the product was coagulated by slowly dripping the mixture into isopropanol with stirring by magnetic stirrer. The precipitate was collected by vacuum filtration and then suspended in methanol (50 mL) and filtered off. The brown solid was air dried for several hours and then vacuum dried at about 60° C. for 2 hours under P₂O₅ to constant weight 0.16 g.

Weight average molar mass of the polymer samples was determined by GPC. The GPC analysis of the polymer samples was performed with a Hewlett Packard 1050 HPLC system and with the diode array detector (λ=230 nm). The chromatographic separation was done using the TSKgel lyotropic G5000 PWXL column (TOSOH Bioscience). A mixture of phosphate buffer 0.1 M (pH=6.9-7.0) and acetonitrile was used as the mobile phase. Chromatographic data were collected and processed using the ChemStation B10.03 (Agilent Technologies) and GPC software Cirrus 3.2 (Varian). Poly(styrenesulfonic acid) sodium salt was used as a GPC standard.

### Example 5

This example describes synthesis of a rigid rod-like macromolecule of the general structural formula (XVIII), where R₁ is CH₃, M is Cs and k is equal to n.

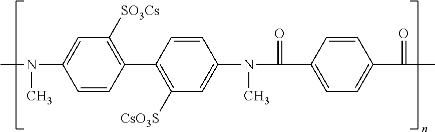

In particular, 30 g 4,4′-Diaminobiphenyl-2,2′-disulfonic acid was mixed with 300 ml pyridine. 60 ml of acetyl chloride was added to the mixture with stirring, and the resulting reaction mass agitated for 2 hours at 35-45° C. Further, it was filtered, and the filter cake was rinsed with 50 ml of pyridine and then washed with 1200 ml of ethanol. The obtained alcohol wet solid was dried at 60° C. The yield of 4,4′-bis(acetylamino)biphenyl-2,2′-disulfonic acid pyridinium salt is 95%.

12.6 g 4,4′-bis(acetylamino)biphenyl-2,2′-disulfonic acid pyridinium salt was mixed with 200 ml DMF. 3.4 g sodium hydride (60% dispersion in oil) was added. The reaction mass was agitated 16 hours at room temperature. 7.6 ml methyl iodide was added, and the reaction mass was stirred 16 hours at room temperature. Then the volatile components of the reaction mixture were distilled off, and the residue washed with 800 ml of acetone and dried. The obtained 4,4′-bis[acetyl(methyl)amino]biphenyl-2,2′-disulfonic acid was dissolved in 36 ml of 4M sodium hydroxide. 2 g activated charcoal was added to the solution and stirred at 80° C. for 2 hours. The liquid was clarified by filtration, neutralized with 35% HCl to pH-1, and reduced by evaporation to 30% by volume. Then it was refrigerated (5° C.) overnight and precipitated material was isolated and dried. The yield of 4,4′-bis[methylamino]biphenyl-2,2′-disulfonic acid was 80%.

2.0 g 4,4′-bis[methylamino]biphenyl-2,2′-disulfonic acid and 4.2 g cesium hydrocarbonate were mixed with 6 ml water. This solution was stirred with IKA UltraTurrax T25 at 5000 rpm for 1 min. Then, 2 ml triethylene glycol dimethyl ether was added, followed by 4.0 ml of toluene with stirring at 20000 rpm for 1 min. Then, a solution of 1.2 g terephtaloyl chloride in 2.0 ml of toluene was added to the mixture at 20000 rpm. The emulsion of polymer was stirred for 60 min, and then poured into 150 ml of ethanol at 20000 rpm. After 20 min of agitation, the suspension of polymer was filtered on a Buchner funnel with a fiber filter, and the resulting polymer dissolved in 8 ml of water, precipitated by pouring into of 50 ml of ethanol and dried 12 hours at 70° C. The yield was 2.3 g.

### Example 6

Example 6 describes synthesis of UV-curable 2,2′-disulfo-4,4′-benzidine fumarylamide-isophthalamide copolymer sodium salt.

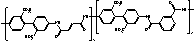

In particular, 15.0 g of 2,5-Diaminobenzene-1,4-disulfonic acid was mixed with 9.7 g of Sodium carbonate in 150 ml of water using a 2 L beaker and stirred until the solid was completely dissolved. Further, 350 ml of toluene was added. Upon stirring the obtained solution at 7000 rpm, a solution of 3.7 g of Fymaryl chloride and 4.9 g of Isophthaloyl chloride in toluene (350 ml) was added. The resulting mixture was stirred for 3 hours. The stirrer was stopped, 600 ml of Acetone was added, and the thickened mixture was crushed with the stirrer to form slurry suitable for filtration. The polymer was filtered and washed twice with 350-ml portions of Acetone. The obtained polymer was dried at 75° C. The GPC molecular weight analysis of the sample was performed as described in Example 1.

### Refractive Index Characteristics of Refractive Index Matching Interlayers

Polymer materials including the polymers listed above can be used to form RI matching interlayers. Optical characteristics, such as refractive indices in each direction, regarding RI matching interlayers based on polymers described herein, are determined by types of polymers (e.g., their length and rigidity), orientation of the polymers, and other factors. Specifically, optical characteristics may be controlled by selection of organic components (Core), side-groups (S), and the number of subunits (i.e., the value of n). By selecting these components and parameters, one may produce positive A-plates, negative C-plates, and Ba-plates. In some embodiments, the birefringence of the deposited RI matching interlayer is at least about 0.05 or, more specifically, in between of about 0.05 and 0.20.

In an example, at least one polymer may be formed in a layer forming a plane in the X and Y directions. The Y direction may be a coating direction. The layer may have a thickness in the Z direction. In some embodiments, the refractive index in the X direction (i.e., nₓ) may be greater than the refractive indices in the Y and Z directions (i.e., n_{y} and n_{z}). The refractive indices in the Y and Z directions (i.e., n_{y} and n_{z}) may be the same. This type of film may be referred to as a positive A-plate. The refractive index in the X direction (i.e., nₓ) may be at least about 1.6, at least about 1.7, or even at least about 1.8. Very few conventional polymers have such high refractive indices. The refractive indices in the Y and Z directions (i.e., n_{y} and n_{z}) may be at least about 1.4 or, more specifically, at least about 1.5. For example, polymers for positive A-plates have shown to have the refractive index in the X direction (i.e., nₓ) of 1.85 and the refractive indices in the Y and Z directions (i.e., n_{y} and n_{z}) of 1.57.

In some embodiments, the refractive index in the X direction (i.e., nₓ) may be substantially the same as the refractive index in the Y direction (i.e., n_{y}) and greater than the refractive index in the Z direction (i.e., n_{z}). This type of film may be referred to as a negative C-plate. The refractive indices in the X and Y directions (i.e., nₓ and n_{y}) may be at least about 1.5, at least about 1.6, or even at least about 1.7, while the refractive index in the Z direction (i.e., n_{z}) may be at least about 1.5 or, more specifically, at least about 1.55. For example, polymers for negative C-plates have been shown to have refractive indices in the X and Y directions (i.e., nₓ and n_{y}) of 1.72 and the refractive index in the Z direction (i.e., n_{z}) of 1.59.

In some embodiments, the refractive index in the X direction (i.e., nₓ) is less than the refractive indices in the Y and Z directions (i.e., n_{y} and n_{z}). The refractive indices in the Y and Z directions (i.e., n_{y} and n_{z}) may be different as well (e.g., the refractive index in the Y direction (i.e., n_{y}) being greater than the refractive index in the Z direction (i.e., n_{z})). This type of film may be referred to as biaxial film. The refractive index in the X direction (i.e., nₓ) may be at least about 1.5 or, more specifically, at least about 1.55.

Overall, some polymer may be formed into a uniaxial retardation layer such that n_{z}<nₓ=n_{y} or nₓ>n_{y}=n_{z}. Other polymers may be formed into a biaxial retardation layer such that nₓ<n_{z}<n_{y}.

### Deposition Methods

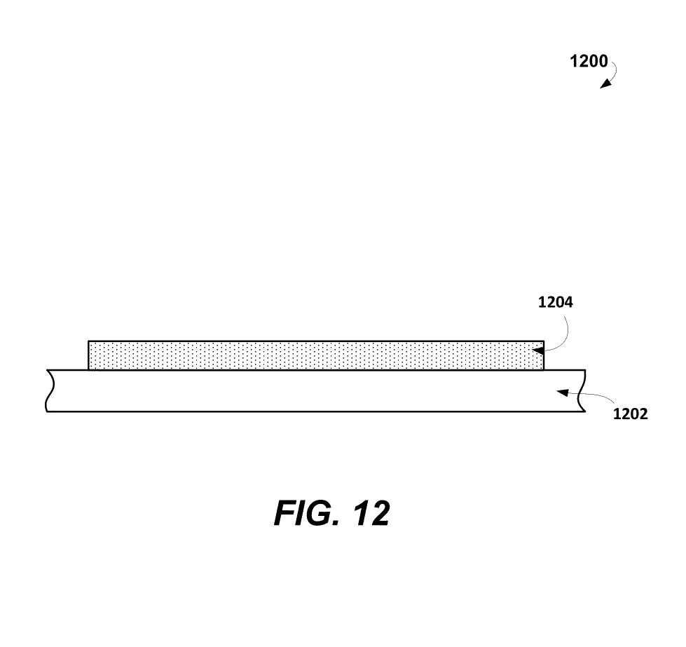

FIG. 12 is a high level illustration 1200 showing a substrate 1202, one surface of which is coated with a polymer film 1204. It should be clear to those skilled in the art that the polymer film 1204 may be deposited onto both sides of the substrate 1202 or more than one coating may be applied to one or both sides of substrate 1202. The substrate 1202 may include, for example, a polymer substrate, glass substrate, TAC substrate, PET substrate, polypropylene substrate, polycarbonate substrate, acryl substrate, PMMA substrate, and so forth. The substrate 1202 may have any suitable form and shape such as flat or having arched plates, or any other complex form depending on an application.

### Examples of Deposition Techniques

Below are provided several examples of deposition techniques used for applying a layer of polymer solution onto a substrate.

### Slot Die Extrusion Example

The slot die technique is generally suitable for depositing uniform layers having a thickness in the range of about 1 micron to about 2000 microns (wet), using solutions (or slurries) having viscosities of 1 cP to 100,000 cP and maintained at temperatures of up to 250° C., and using linear speeds of up to 150 meters per minute. The viscosity of the coated polymer may be controlled by molecular weight, solid content, additives, and temperature. Viscosity may impact flow characteristics of polymer solutions, shear stresses applied to the forming film, and, as a result, alignment of polymer molecules within a deposited layer and resulting optical characteristics of the layer. The polymer solution temperature, which may be referred to as a feeding temperature, may be between about 10° C. and 80° C. Below 10° C., the water in a water soluble polymer gets closer to its freezing point, while temperatures above 80° C. may cause rapid evaporation and loss of water resulting in a system that may be difficult to control. Before deposition, it should be ensured that the polymer solution is homogeneous, which may be done by warming and/or stirring. At this step, one or more additives may be added to the polymer solution based on an application or certain tasks.

The provided solution is then deposited onto the substrate as a thin layer. As noted above, the polymer solution may be deposited onto a substrate or be formed into freestanding structures, according to one or more embodiments described above. The thickness of the deposited layer may depend on one or more of the following: a substrate feed speed, substrate width, polymer solution feed rate, and solids content. The substrate feeding speed may be in between 0.5 meters per minute and 500 meters per minute or, more specifically, between 2 meters per minute and 20 meters per minute. While faster speeds are beneficial from the process throughput perspective, the feeding speed may be controlled to achieve specific shear forces for redistributing and aligning polymer molecules within the deposited layer. The feeding rate of polymer solution may be between 1 gram per minute and 2500 grams per minute. In some embodiments, deposited film thickness may be between 10 microns and 2000 microns or, more specifically, between 25 microns and 250 microns. This is the thickness of the wet coating and changes substantially during drying. As noted above, the degree of change (i.e., the shrinkage ratio) depends on the solid content and other factors.

When the slot-die technique is used, slot die lips may be separated by a distance between 10 microns and 1000 microns or, more specifically, between 25 microns and 250 microns. The lip separation may determine pressure in the die and, therefore, the film thickness uniformity. Additionally, the slot die is spaced relative to the substrate and allows the polymer solution to flow onto the substrate and be deposited as a uniform layer. In some embodiments, the gap between the slot die and the substrate is between 10 microns and 1000 microns or, more specifically, between 25 microns and 250 microns, and may be varied to control coating quality.

In order to better understand some equipment based parameters, such as spacer thicknesses, substrate feeding speed, and solution feeding rates, a brief description of the slot die coating system may be helpful. A slot die coating system may include five main components: a die, a die positioner, a roll, a fluid delivery system, and a substrate. The die determines the rate of polymer solution dispensing onto the substrate. The fluid rheology (e.g., pressure, viscosity, and surface tension) is a contributing factor together with a design and position of the die. Some polymer based solutions have specific rheological properties that require specific design of the die (e.g., the internal flow geometry). The die manifold is the contoured flow geometry machined into the body sections of the die. The function of the die is to maintain the solution at the proper temperature for application, distribute it uniformly to the desired coating width, and apply it to the substrate. The manifold distributes the coating fluid that enters the die to its full target width and is designed to generate a uniform, streamlined flow of material through the exit slot of the die. The die positioner is an adjustable carriage that precisely positions the slot die at the optimum angle and proximity to the roll and isolates the die from vibrations that can affect coating application. The die positioner stabilizes the interaction between the die and the moving substrate, sets the angle of dispensing between the die and substrate, and sets the distance between the die and substrate. The roll provides a precisely positioned surface with respect to the die position and is used for supporting the substrate. The fluid delivery system is used to provide a constant feed of polymer solution into the die. The fluid delivery system may determine the coat weighting weight and thickness of the deposited layer.

### Examples of Removing Solvent Technique

The solvent may be removed by drying at temperatures of at least about 80° C. The upper limit is generally determined by the stability of the polymer used in the solution. These temperatures may represent the actual temperature of the material during its drying or the temperature of surrounding components, such as the temperature of the substrate, the temperature of atmosphere over the surface of the material, and the like. The drying may be also performed by blowing drying gas at specific temperatures. For example, the drying gas may include nitrogen or heated air. In general, higher temperatures are preferred to expedite the drying process. However, fast removal of water may disturb the arrangement of polymer molecules within the drying structure and distort optical properties.

In certain example embodiments, the drying process may include multiple steps. For example, the drying by heating may also include subsequent cooling of the polymer solution. In various embodiments, one or more drying devices may be utilized such as flash dryers, rotary dryers, spray dryers, fluidized bed dryers, vibrated fluidized beds, contact fluid-bed dryers, plate dryers, and so forth.

### Roll-To-Roll Deposition Example

When a roll-to-roll technique is used (which is also known as web processing or reel-to-reel processing), a polymer solution may be deposited on a substrate presented in the form of a roll of film. The deposition may be made using any suitable technique. In an example, the deposition may include the use of an applicator, which may be adjusted by a sheer force (a knife) on a moving substrate. The deposition may be performed such that further drying technique is applied, or UV cross-linking techniques are utilized as described below. Once the substrate film has been coated, it is rolled onto another roll and may then be slit to a desired size on a slitter and/or cut to final size on a shear, or be further processed by embossing, subjecting to high-temperature, or dipping to barium chloride solution (alone or combined) as further described below.

As noted above, before deposition, homogeneity of the polymer solution should be ensured. The web speed and/or coating solution flow rate should be set so as to control desired shear stress and coating thickness. The polymer solution solids concentration and feed temperature should be also set.

In an example, the substrate was coated with the polymer solution to exhibit a negative C-plate behavior with out of plane retardation values (Rth) defined as:

Rth=thickness*(n_{z}−nₓ)

The Rth values may be controlled by dry coating thickness. Table 1 below shows various wet thicknesses achieved during the deposition technique of a polymer containing 2,2′-disulfo-4,4′-benzidine terephthalamide-isophthalamid (hereinafter referred to as “POLYMER 1”) of known solids concentration (N) and flow rate through an 11-inch wide shim at 25 ft/min.

TABLE 1

| | | | | Calculated | Measured | |
|---|---|---|---|---|---|---|
| | Coat | Web | Flow | wet | dry | Measured - |
| N | width | speed | rate | thickness | thickness | Rth @ 550 nm |
| % | ft | ft/min | g/min | micrometer | micrometer | Nanometer |
| 4.0 | 0.92 | 25 | 89.2 | 41.9 | 1.36 | 177 |
| 4.0 | 0.92 | 25 | 136.4 | 64.1 | 2.07 | 250 |
| 4.0 | 0.92 | 25 | 143.7 | 67.5 | 2.26 | 261 |
| 7.1 | 0.92 | 25 | 218.8 | 182.4 | 5.85 | 587 |

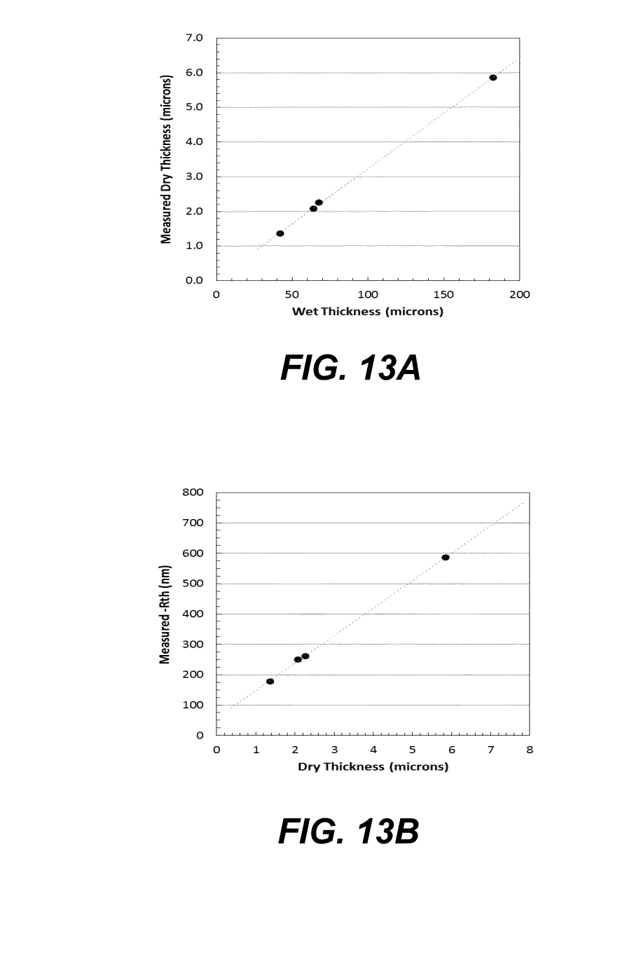

The dry thickness measurement of the deposited polymer solution is linear with the set wet thickness (though not exactly by 4% since the polymer film compacts upon drying). It can be predicted that the measured Rth is linear with the thickness of the POLYMER 1 layer. Thus, the retardance may be controlled through the deposition conditions and characteristics. This is further illustrated in FIGS. 13A and 13B, which show dry thickness dependency against wet thickness (FIG. 13A) and retardation dependency against dry thickness (FIG. 13B). It should be noted that the wet thickness vs. dry thickness curve will change with solid concentration of the applied solution.

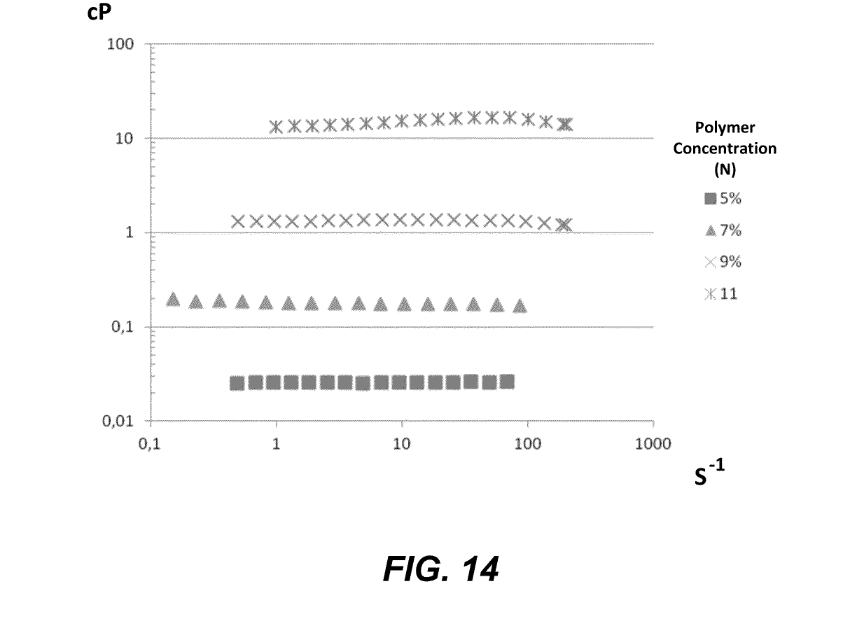

As already noted, the viscosity of the coated polymer solution may be controlled by various parameters such as a molecular weight, solid content concentration, temperature, and so forth. Viscosity may also impact flow and characteristics of polymer solutions, shear stresses applied to the forming polymer solution film, and, as a result alignment of polymer molecules within a deposited layer and resulting optical characteristics of the optical layer. FIG. 14 shows measured dependencies of viscosity (cP) as a function of shear rate (s⁻¹) for different polymer concentrations (N).

### Post-Deposition Treating Techniques

### Shaping

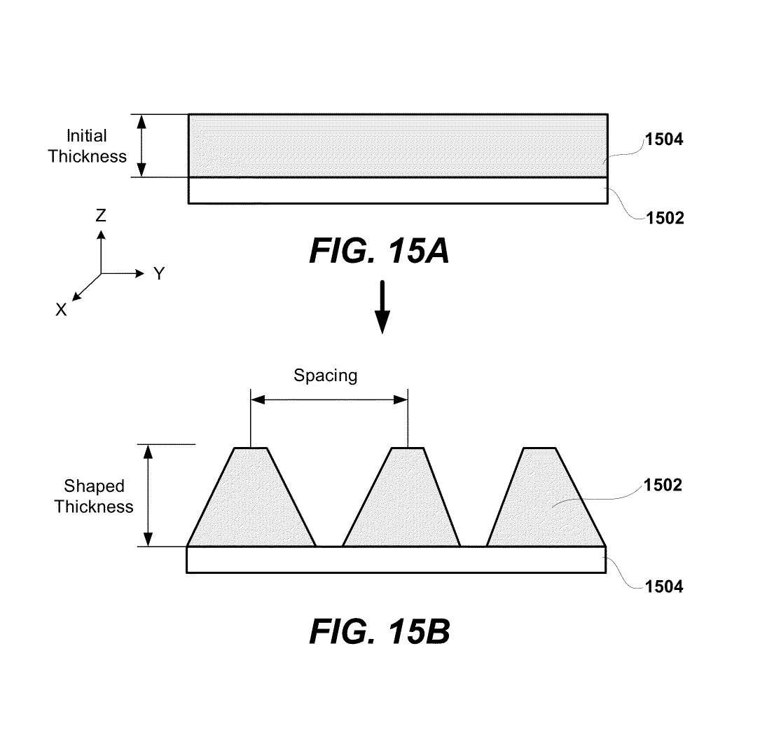

In various embodiments, post-deposition treating operations may involve shaping of polymer solution layer. For example, a polymer solution layer may be embossed to form grooves, for example, as shown in FIGS. 15A and 15B. Specifically, in FIG. 15A there is shown a substrate 1502 having a polymer solution layer 1504 deposited on top thereof. FIG. 15B shows the result of grooving of the polymer solution layer 1502, namely creating shaped polymer coating 1502. Shaping of the polymer solution layer may be performed on a fully dried polymer structure (i.e., the solid content of about 100%), on a partially dried polymer structure, or on a deposited polymer coating before any drying occurs. In the latter two cases, the shaping device (e.g., an embossing roll) may need to accommodate for subsequent changes in thickness. As such, the tolerance of the shaping devices used in these cases may not need to be as precise as for the device used on a fully drier polymer structure.

Shaping of the polymer structures (regardless of their drying state) may be performed while the polymer structures are kept between about 50° C. and 200° C. The shaping tool may be also heated to this temperature range. In some embodiments the shaping tool is heated to between about 100° C. and 200° C. while the polymer structures may be maintained at the same temperature or lower temperature prior to contacting the shaping tool. One having ordinary skills in the art would understand that some drying may occur at these conditions if the polymer structures still have solvent. In some embodiments, some drying is performed after the polymer structure is shaped. This post-shaping drying may be performed in addition to pre-shaping drying.

In yet another example, the solid content of the dry polymer can be reduced by adding solvent. This may be done in order, for example, to reshape the polymer. Furthermore, the fully or partially dry polymer may be extruded into fibers and hollow tubes. Unlike conventional extrusion in which thermoplastic polymers are heated to make them conformal, water can be added to the water soluble polymers before shaping or extrusion.

### Cross-Linking

The post-deposition treating operation may also involve cross-linking of polymer chains by one or more of the following techniques: UV light radiation, IR light radiation, or other types of activation energy sources such as electron, ion, or gamma radiation. In certain embodiments, cross-linking of polymer chains may include subjecting the polymer molecules to react with specific additives or proprietary compositions. The cross-linking may involve forming links between two or more adjacent polymer molecules and/or extending polymer molecules by linking end groups. Examples of UV sensitive groups responsible for cross-linking may include carbon double bonds and carbon triple bonds. The groups may be introduced into some or all monomers during their synthesis. The groups may be relatively inactive during coating and partial or even entire drying operations but capable of activating after coating and, in some embodiments, after partial or complete drying. In various example embodiments, UV light radiation may have specific wavelengths, for example, in the range between about 180 nanometers and 400 nanometers.

One example of UV cross-linking will now be described in more detail. A polymer as shown below may be formed into a negative C-plate. When a deposited polymer film is subjected to UV light irradiation, the irradiated polymer film becomes less soluble before any further post-treatment, such as exposing to metal cations for cross-linking. Without being restricted to any particular theory, it is believed that double bonds present in each polymer molecule react under UV-irradiation to form inter-molecular bonds with adjacent molecules. Below is shown an example cross-linking of polymers having structural formulas:

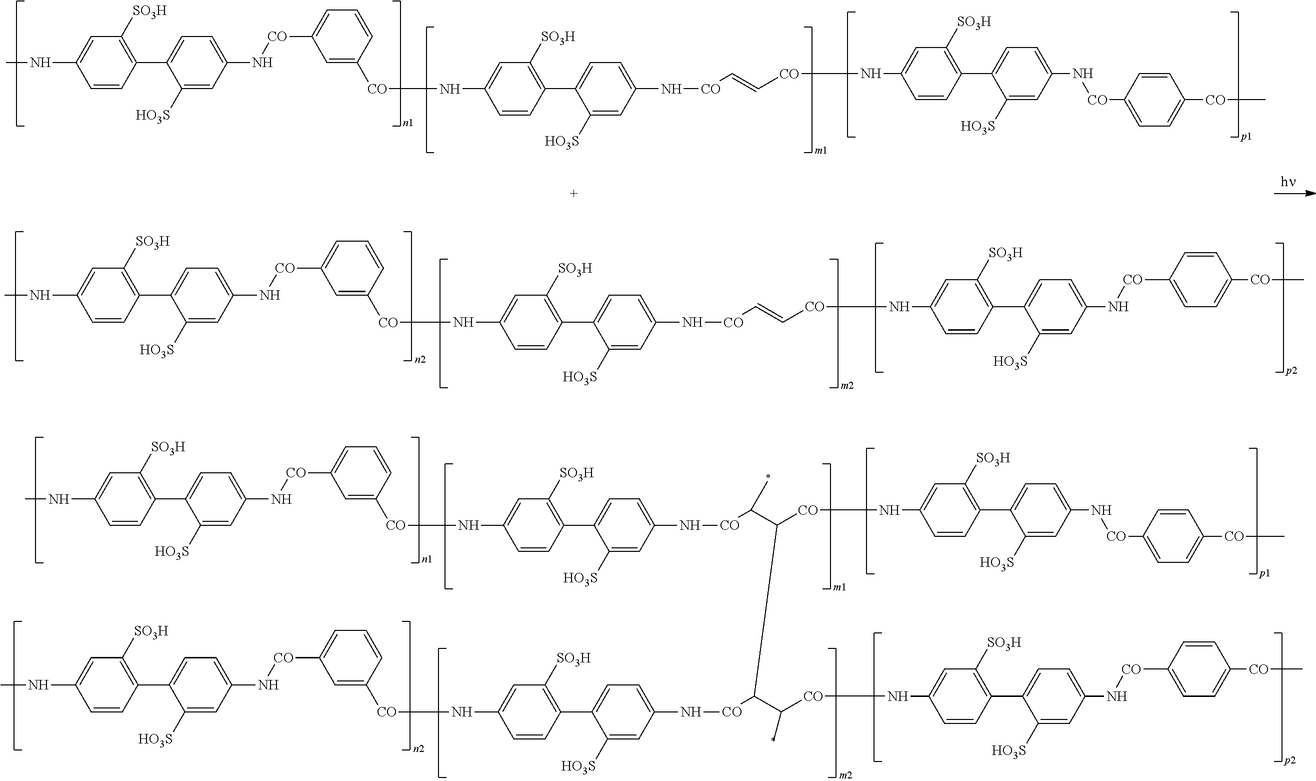

Another example is presented by the formula shown below. The polymer uses chain terminators to control the molecular weight. Without these chain terminators, the material may extend to a molecular weight of 220,000 units and become insoluble. With the chain terminators, the molecular weight may be reduced to about 20,000 units and has sufficient solubility. These chain terminators may be UV-curable groups (e.g., C═C double and C—C triple bonds) that could be easily activated to increase the molecular weight in the film after coating, to provide a 3D network, and to reduce solubility. This example is further illustrated by the following structural formulas:

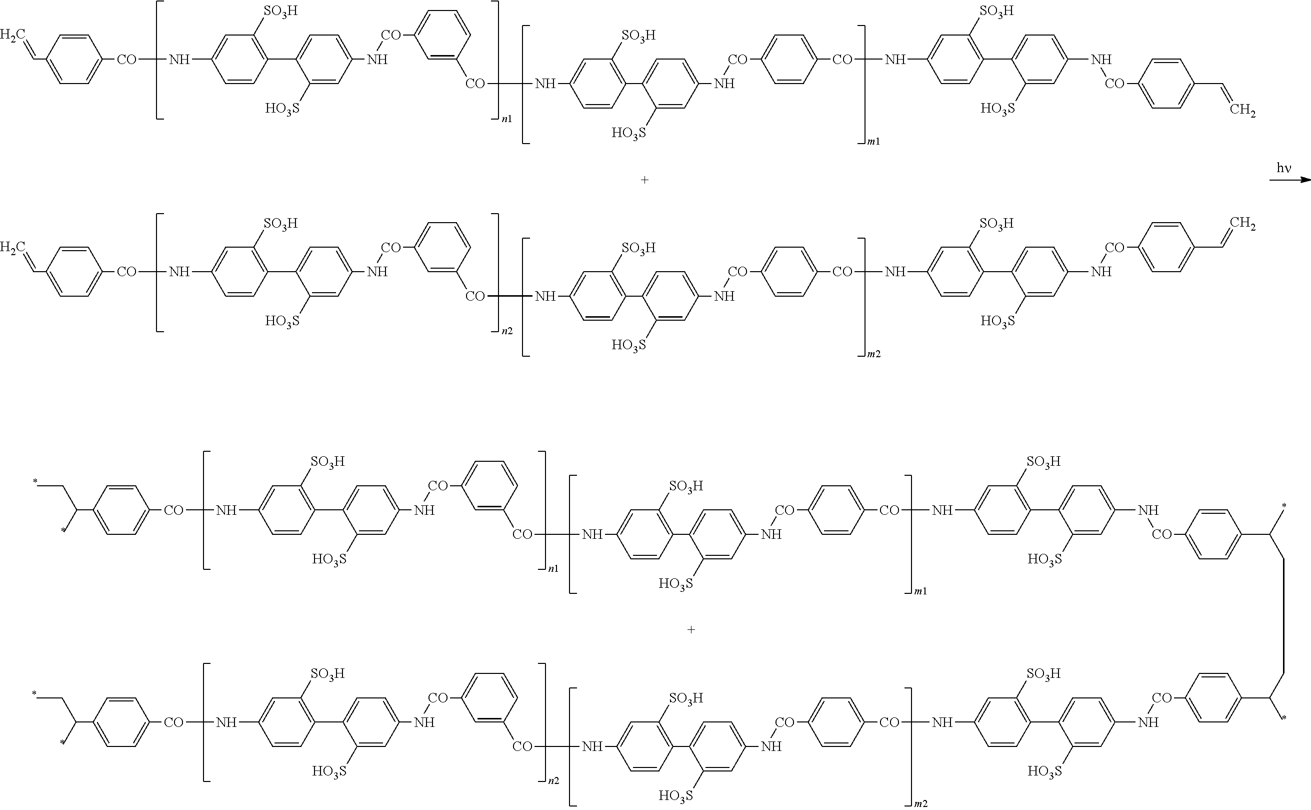

Asterisks as shown above designate continuations of the polymeric chains.

In addition to above, it should be noted that polymer materials discussed herein are very stable against heating (e.g., 150° C. or even more). In this regard, RI matching layers based on the polymers discussed herein may also provide thermal protection to a substrate or related layers of discussed touch panels. Indeed, while many deposition or cross-linking techniques require heating of certain elements, plastic or glass substrates may be easily damaged by the formation of multiple micro-cracks on their surfaces. This damage may lead to light distortion and unwanted worsening of optical characteristics. However, when a refractive index-matching layer based on the polymers discussed herein is applied to the substrate, it may not only protect against overheating and reduce the number of micro-cracks appearing in the substrate, but it may also fill those cracks that are present on the face surface of the substrate during the deposition process or the later post-deposition steps. Thus, the polymers of the present disclosure are very attractive materials for various multi-layered display devices.

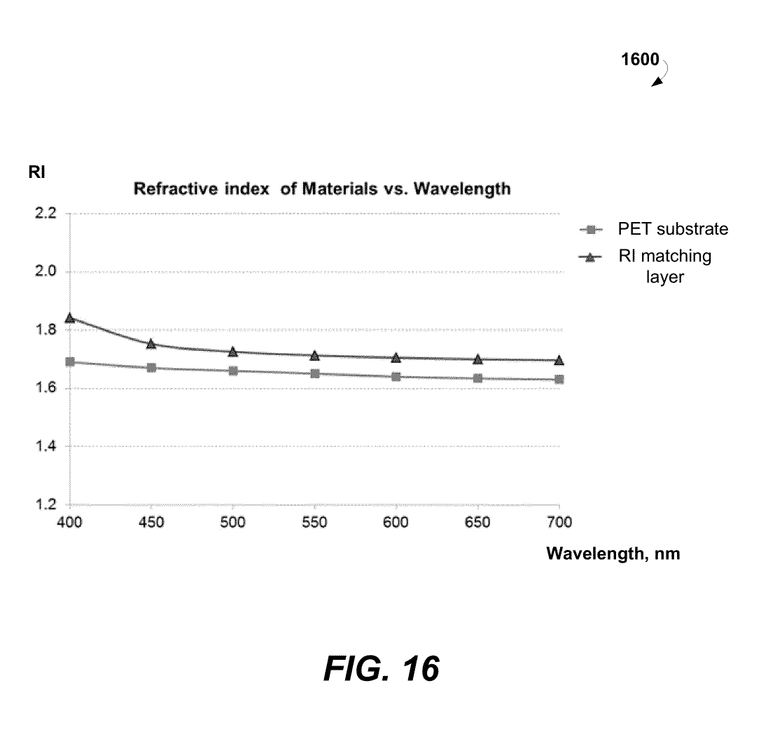

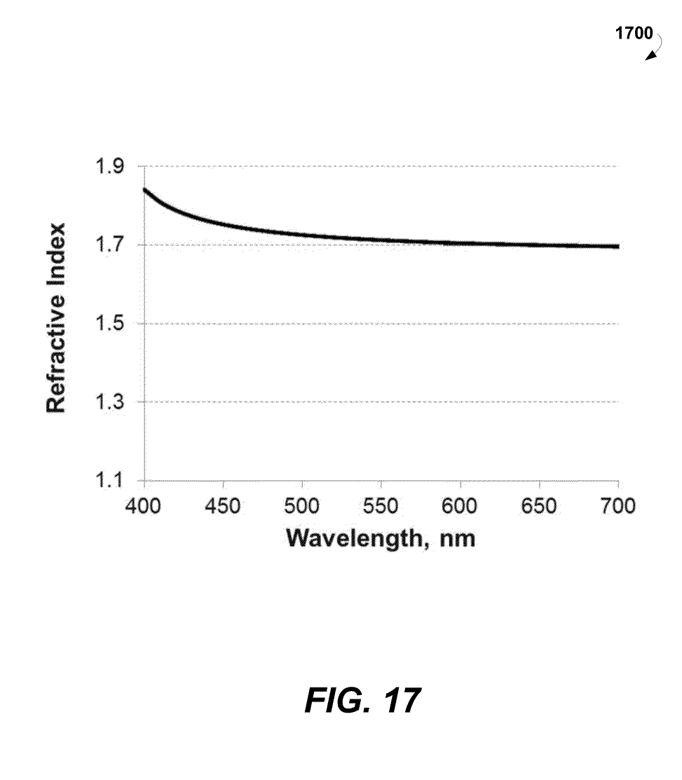

It should be also noted that the polymers discussed herein, which serve as a basis for refractive index-matching interlayers, have very stable refractive indexes within a wide range of visible light. FIG. 16 shows an exemplary diagram 1600 of refractive index dependency for a substrate and RI matching layer against a wavelength. It is obvious that the refractive index of the RI matching layer is consistent along a wide range of wavelengths. In-plane refractive index of the RI matching interlayers may be also substantially unchanged in a wide range of wavelengths, which is illustrated in an example diagram 1700 on FIG. 17.

### CONCLUSION

Thus, various backlight unit stacks and methods of forming such stacks involving deposition of specific single layer or multilayered RI matching interlayers and PSA or air gap interlayers have been disclosed. Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses disclosed herein. Accordingly, the present embodiments are to be considered as illustrative and not restrictive.

What is claimed is:

1. A multilayer stack for reducing light losses in a liquid crystal display (LCD) backlight, the multilayer stack comprising:
a reflector;
a light guide;
a course diffuser;
a brightness enhancing film;
a fine diffuser;
one or more refractive index matching layers deposited onto one surface of the reflector, and onto at least one surface of at least one of the light guide, the course diffuser, the brightness enhancing film, and the fine diffuser; and
one or more pressure sensitive adhesives (PSA) deposited onto the one or more refractive index matching layers.

2. The multilayer stack of claim 1, wherein the reflector includes a white reflector, an aluminized substrate, a Titanium Dioxide coated substrate, a glass, a polyolefin, a polycarbonate, a polyamide, a polyimide, a cycloolefin polymer, a cycloolefin copolymer, a polyacryl, polystyrene, a polyethylene terephthalate (PET) based material or a triacetyl cellulose (TAC) based material.

3. The multilayer stack of claim 1, wherein the fine diffuser is disposed adjacent to a rear polarizer stack of an LCD.

4. The multilayer stack of claim 1, wherein the light guide, the course diffuser, the fine diffuser, and the brightness enhancing film, include poly-methyl methacrylate (PMMA), poly carbonate (PC), PET, poly butylenes terephtalate (PBT), or poly ethylene (PE), or combinations thereof.

5. The multilayer stack of claim 4, wherein:
a refractive index of a refractive index matching layer deposited onto the reflector is greater than the refractive index of the reflector,
a refractive index of a refractive index matching layer deposited over the light guide is greater than the refractive index of the light guide,
a refractive index of a refractive index matching layer deposited over the course diffuser is greater than the refractive index of the course diffuser,
a refractive index of a refractive index matching layer deposited over the brightness enhancing film is greater than the refractive index of the brightness enhancing film; and
a refractive index of a refractive index matching layer deposited over the fine diffuser is greater than the refractive index of the fine diffuser.

6. The multilayer stack of claim 1, further comprising:
an additional brightness enhancing film disposed between the brightness enhancing film and the fine diffuser;
a refractive index matching layer deposited onto at least one surface of the additional brightness enhancing film; and
a pressure sensitive adhesive deposited onto the refractive index matching layer.

7. The multilayer stack of claim 6, wherein the additional brightness enhancing film include PMMA, PC, PET, PBT, or PE, or combinations thereof.

8. The multilayer stack of claim 6, wherein a refractive index matching layer deposited onto the additional brightness enhancing film is greater than the refractive index of the additional brightness enhancing film.

9. The multilayer stack of claim 1, wherein a refractive index of each of the one or more PSA is substantially equal to a refractive index of an uncoated element onto which the PSA is deposited, wherein the uncoated element includes the reflector, the light guide, the course diffuser, the brightness enhancing film, and the fine diffuser.

10. The multilayer stack of claim 1, wherein the one or more refractive index matching layers include a polymer solution, wherein the polymer solution comprises at least a polymer, the polymer comprises n organic units having the following structural formula:
[-(Core(S)m)k-Gl-]n,
wherein the organic units comprise rigid conjugated organic component Core, wherein G is a spacer selected from the list comprising —C(O)—NR1-, ═(C(O))2=N—, —O—NR1-, linear and branched (C1-C4) alkylenes, —CR1R2-O—C(O)—CR1R2-, —C(O)—O—, —O—, —NR1-, wherein R1 and R2 are independently selected from the list comprising H, alkyl, alkenyl, alkynyl, aryl; wherein S are lyophilic side-groups providing solubility to the polymer in the solvent and which are the same or different and independently selected from the list comprising one or more of the following: —COOX, —SO3X, wherein X is selected from the list comprising H, alkyl, alkenyl, alkynyl, aryl, alkali metal, NW4, wherein W is H or alkyl or any combination thereof, —SO2NP1P2 and —CONP1P2, wherein P1 and P2 are independently selected from the list comprising H, alkyl, alkenyl, alkynyl, aryl; and wherein m is 0, 1, 2, or 3, and wherein k is 1, 2, or 3.

11. A multilayer stack for reducing light losses in a liquid crystal display (LCD) backlight, the multilayer stack comprising:
a reflector;
a light guide;
a course diffuser;
a brightness enhancing film;
a fine diffuser; and
two or more refractive index matching layers deposited onto one surface of the reflector, and onto each surface of at least one of the light guide, the course diffuser, the brightness enhancing film, and the fine diffuser;
wherein an air gap is present between each two adjacent elements, wherein the elements include the reflector, the light guide, the course diffuser, the brightness enhancing film, and the fine diffuser.

12. The multilayer stack of claim 11, wherein the fine diffuser is disposed adjacent to a rear polarizer stack of an LCD, wherein an air gap is present between the fine diffuser and the rear polarizer stack.

13. The multilayer stack of claim 11, further comprising:
an additional brightness enhancing film disposed between the brightness enhancing film and the fine diffuser; and
two or more refractive index matching layers deposited onto at least one surface of the additional brightness enhancing film;
wherein an air gap is present between the brightness enhancing film and the additional brightness enhancing film, and between the additional brightness enhancing film and the fine diffuser.

14. The multilayer stack of claim 11, wherein each of the two or more refractive index matching layers forms a complex layer configured to reduce light losses due to reflections and scattering relative to the losses due to reflections and scattering at the boundary of an uncoated component and the air gap, wherein the uncoated element includes the reflector, the light guide, the course diffuser, the brightness enhancing film, and the fine diffuser.

15. The multilayer stack of claim 11, wherein the two or more refractive index matching layers include a polymer solution, wherein the polymer solution comprises at least a polymer, the polymer comprises n organic units having the following structural formula:
[-(Core(S)m)k-Gl-]n,
wherein the organic units comprise rigid conjugated organic component Core, wherein G is a spacer selected from the list comprising —C(O)—NR1-, ═(C(O))2=N—, —O—NR1-, linear and branched (C1-C4) alkylenes, —CR1R2-O—C(O)—CR1R2-, —C(O)—O—, —O—, —NR1-, wherein R1 and R2 are independently selected from the list comprising H, alkyl, alkenyl, alkynyl, aryl; wherein S are lyophilic side-groups providing solubility to the polymer in the solvent and which are the same or different and independently selected from the list comprising one or more of the following: —COOX, —SO3X, wherein X is selected from the list comprising H, alkyl, alkenyl, alkynyl, aryl, alkali metal, NW4, wherein W is H or alkyl or any combination thereof, —SO2NP1P2 and —CONP1P2, wherein P1 and P2 are independently selected from the list comprising H, alkyl, alkenyl, alkynyl, aryl; and wherein m is 0, 1, 2, or 3, and wherein k is 1, 2, or 3.

16. A method for forming a multilayer stack for reducing light losses in a liquid crystal display (LCD) backlight, an LCD rear polarizer stack, an LCD panel, and a front polarizer stack, the method comprising:
providing a reflector, a light guide, a course diffuser, a brightness enhancing film, and a fine diffuser;
depositing a refractive index matching layer onto one surface of the reflector, and onto at least one surface of at least one of the light guide, the course diffuser, the brightness enhancing film, and the fine diffuser;
depositing a pressure sensitive adhesive (PSA) onto one or more refractive index matching layers;
disposing the reflector, the light guide, the course diffuser, the brightness enhancing film, and the fine diffuser disposed on one another.

17. The method of claim 16, further comprising disposing the fine diffuser adjacent to a polarizer of the LCD.

18. The method of claim 16, wherein the reflector includes an aluminized substrate, a Titanium Dioxide coated substrate, a glass, a polyolefin, a polycarbonate, a polyamide, a polyimide, a cycloolefin polymer, a cycloolefin copolymer, a polyacryl, polystyrene, a polyethylene terephthalate (PET) based material, a triace tyl cellulose (TAC) based material or a simple white reflector

19. The method of claim 16, wherein the light guide, the course diffuser, the fine diffuser, and the brightness enhancing film include poly-methyl methacrylate (PMMA), poly carbonate (PC), PET, poly butylenes terephtalate (PBT), or poly ethylene (PE), or combinations thereof.

20. The method of claim 16, wherein:
a refractive index of a refractive index matching layer deposited onto the reflector is greater than the refractive index of the reflector;
a refractive index of a refractive index matching layer deposited over the light guide is greater than the refractive index of the light guide;
a refractive index of a refractive index matching layer deposited over the course diffuser is greater than the refractive index of the course diffuser;
a refractive index of a refractive index matching layer deposited over the brightness enhancing film is greater than the refractive index of the brightness enhancing film; and
a refractive index of a refractive index matching layer deposited over the fine diffuser is greater than the refractive index of the fine diffuser.

21. The method of claim 16, further comprising:
providing an additional brightness enhancing film;
depositing a refractive index matching layer onto at least one surface of the additional brightness enhancing film; and
disposing the additional brightness enhancing film between the brightness enhancing film and the fine diffuser.

22. The method of claim 21, wherein the additional brightness enhancing film includes one or more of PMMA, PC, PET, PBT, and PE.

23. The method of claim 21, wherein a refractive index matching layer deposited onto the additional brightness enhancing film is greater than the refractive index of the additional brightness enhancing film.

24. The method of claim 16, wherein a refractive index of each of the one or more PSA is substantially equal to a refractive index of an uncoated surface of the element disposed over the PSA and less than the refractive index of the refractive index matching layer coated on the surface of the element disposed under the one or more PSA, wherein the element includes the reflector, the light guide, the course diffuser, the brightness enhancing film, and the fine diffuser.

25. The method of claim 16, wherein the one or more refractive index matching layers include a polymer solution, wherein the polymer solution comprises at least a polymer, the polymer comprises n organic units having the following structural formula:
[-(Core(S)m)k-Gl-]n,
wherein the organic units comprise rigid conjugated organic component Core, wherein G is a spacer selected from the list comprising —C(O)—NR1-, ═(C(O))2=N—, —O—NR1-, linear and branched (C1-C4) alkylenes, —CR1R2-O—C(O)—CR1R2-, —C(O)—O—, —O—, —NR1-, wherein R1 and R2 are independently selected from the list comprising H, alkyl, alkenyl, alkynyl, aryl; wherein S are lyophilic side-groups providing solubility to the polymer in the solvent and which are the same or different and independently selected from the list comprising one or more of the following: —COOX, —SO3X, wherein X is selected from the list comprising H, alkyl, alkenyl, alkynyl, aryl, alkali metal, NW4, wherein W is H or alkyl or any combination thereof, —SO2NP1P2 and —CONP1P2, wherein P1 and P2 are independently selected from the list comprising H, alkyl, alkenyl, alkynyl, aryl; and wherein m is 0, 1, 2, or 3, and wherein k is 1, 2, or 3.

26. The method of claim 16, wherein the depositing of the refractive index matching layer includes one or more of the following techniques: slot die extrusion, Mayer rod coating, roll coating, gravure coating, micro-gravure coating, comma coating, knife coating, extrusion, printing, spray coating, and dip coating.

27. A method for forming a multilayer stack for reducing light losses in a liquid crystal display (LCD) backlight, an LCD rear polarizer stack, an LCD panel, and a front polarizer stack, the method comprising:
providing a reflector, a light guide, a course diffuser, a brightness enhancing film, and a fine diffuser;
depositing two or more refractive index matching layer onto one surface of the reflector, and onto both surfaces of at least one of the light guide, the course diffuser, the brightness enhancing film, and the fine diffuser;
disposing the reflector, the light guide, the course diffuser, the brightness enhancing film, and the fine diffuser so that an air gap is present between two adjacent elements, wherein the elements include the reflector, the light guide, the course diffuser, the brightness enhancing film, and the fine diffuser.

28. The method of claim 27, further comprising disposing the fine diffuser adjacent to a polarizer of the LCD so that an air gap is present between the fine diffuser and the rear polarizer stack.

29. The method of claim 27, further comprising:
providing an additional brightness enhancing film;
depositing two or more refractive index matching layers onto both surfaces of the additional brightness enhancing film; and
disposing the additional brightness enhancing film between the brightness enhancing film and the fine diffuser so that an air gap is present between the brightness enhancing film and the additional brightness enhancing film, and between the additional brightness enhancing film and the course diffuser.

30. The method of claim 27, wherein each of the two or more refractive index matching layers forms a complex layer configured to reduce light losses due to reflections and scattering relative to the losses due to reflections and scattering at the boundary of an uncoated component and the air gap, wherein the uncoated element includes the reflector, the light guide, the course diffuser, the brightness enhancing film, and the fine diffuser.

31. The method of claim 27, further comprising depositing one or more pressure sensitive adhesives onto the two or more refractive index matching layers.

32. The method of claim 27, wherein the one or more refractive index matching layers include a polymer solution, wherein the polymer solution comprises at least a polymer, the polymer comprises n organic units having the following structural formula:
[-(Core(S)m)k-Gl-]n,
wherein the organic units comprise rigid conjugated organic component Core, wherein G is a spacer selected from the list comprising —C(O)—NR1-, ═(C(O))2=N—, —O—NR1-, linear and branched (C1-C4) alkylenes, —CR1R2-O—C(O)—CR1R2-, —C(O)—O—, —O—, —NR1-, wherein R1 and R2 are independently selected from the list comprising H, alkyl, alkenyl, alkynyl, aryl; wherein S are lyophilic side-groups providing solubility to the polymer in the solvent and which are the same or different and independently selected from the list comprising one or more of the following: —COOX, —SO3X, wherein X is selected from the list comprising H, alkyl, alkenyl, alkynyl, aryl, alkali metal, NW4, wherein W is H or alkyl or any combination thereof, —SO2NP1P2 and —CONP1P2, wherein P1 and P2 are independently selected from the list comprising H, alkyl, alkenyl, alkynyl, aryl; and wherein m is 0, 1, 2, or 3, and wherein k is 1, 2, or 3.
